(19) United States
(12) Patent Application Publication
(10) Pub. No.: US 2022/0042842 A1
(43) Pub. Date: Feb. 10, 2022

(54) DEVICE FOR VEHICLE INCLUDING POWER TRANSFER DEVICE

(71) Applicant: TOYOTA JIDOSHA KABUSHIKI KAISHA, Toyota-shi (JP)

(72) Inventors: Hideaki BUNAZAWA, Nagoya-shi (JP); Tetsuya YOSHIKAWA, Toyota-shi (JP); Kei YUASA, Toyota-shi (JP); Kenichi YAMAGUCHI, Chiryu-shi (JP)

(73) Assignee: TOYOTA JIDOSHA KABUSHIKI KAISHA, Toyota-shi (JP)

(21) Appl. No.: 17/375,379

(22) Filed: Jul. 14, 2021

(30) Foreign Application Priority Data
Aug. 7, 2020 (JP) 2020-135298

(51) Int. Cl. G01H 1/00; F16H 7/08; F16H 61/66

(52) U.S. Cl. CPC G01H 1/003; F16H 7/08; F16H 2061/66277; F16H 2007/0876; F16H 61/66

(57) ABSTRACT

A device for a vehicle including a power transfer device, the power transfer device having an input pulley, an output pulley, and an endless rotary member, the device including: a memory configured to store mapping data that include data that prescribe mapping that represents correspondence between an input variable and an output variable, the data being learned through machine learning, the input variable being at least one of input rotational speed-related data, and output rotational speed-related data, the output variable specifying whether an abnormality is caused in the endless rotary member; and a processor configured to acquire the input variable, acquire the output variable corresponding to the input variable using the mapping data, and determine, based on the output variable, whether an abnormality is caused in the endless rotary member.

### CROSS-REFERENCE TO RELATED APPLICATION

This application claims priority to Japanese Patent Application No. 2020-135298 filed on Aug. 7, 2020, incorporated herein by reference in its entirety.

### BACKGROUND

### 1. Technical Field

The present disclosure relates to a device for a vehicle including a power transfer device.

### 2. Description of Related Art

Japanese Unexamined Patent Application Publication No. 9-65501 (JP 9-65501 A) describes an example of a vehicle that includes a motor/generator, a continuously variable transmission, and a temperature sensor that detects the temperature of oil that circulates in the motor/generator and the continuously variable transmission. According to JP 9-65501 A, it is determined that an abnormality is caused in the motor/generator or the continuously variable transmission when a detection value of the temperature sensor is equal to or more than a threshold.

### SUMMARY

In a continuously variable transmission that includes an endless rotary member such as a belt, occurrence of an abnormality of the endless rotary member is preferably detectable. The temperature of oil that circulates in the continuously variable transmission may be varied between when an abnormality is caused in the endless rotary member and when an abnormality is caused in a part other than the endless rotary member, among constituent parts of the continuously variable transmission. Therefore, it is not possible to determine whether an abnormality is caused in the endless rotary member when an abnormality is determined using the temperature of oil that circulates in the continuously variable transmission.

An aspect of the present disclosure relates to a device for a vehicle including a power transfer device, the power transfer device having an input pulley to which torque is input, an output pulley that outputs torque toward drive wheels of the vehicle, and an endless rotary member wound around both the input pulley and the output pulley, the device including: a memory configured to store mapping data that include data that prescribe mapping that represents correspondence between an input variable and an output variable, the data being learned through machine learning, the input variable being at least one of: input rotational speed-related data based on chronological data on input rotational speeds that are rotational speeds of the input pulley, and output rotational speed-related data based on chronological data on output rotational speeds that are rotational speeds of the output pulley, the output variable specifying whether an abnormality is caused in the endless rotary member; and a processor configured to acquire the input variable, acquire the output variable corresponding to the input variable using the mapping data, and determine, based on the output variable, whether an abnormality is caused in the endless rotary member.

When output torque from the power source is transferred to the drive wheels via the power transfer device, the endless rotary member is rotated while being maintained in the state of being wound around both the input pulley and the output pulley. Consequently, torque input from the power source to the power transfer device is output toward the drive wheels. Under circumstances in which the power transfer device is operating in this manner, the rotational speeds of the input pulley and the output pulley are periodically vibrated when an abnormality is not caused in the endless rotary member. When an abnormality is caused in the endless rotary member, on the other hand, vibration components due to the abnormality caused in the endless rotary member are superimposed on the rotational speeds of the input pulley and the output pulley. Therefore, it is possible to estimate whether an abnormality is caused in the endless rotary member by analyzing transitions in the rotational speed of at least one of the input pulley and the output pulley.

In the configuration described above, the memory stores mapping data that prescribe mapping that represents correspondence between an input variable which is at least one of the input rotational speed-related data and the output rotational speed-related data, and an output variable that specifies whether an abnormality is caused in the endless rotary member. Then, determination is made whether an abnormality is caused in the endless rotary member based on the output variable that is based on the acquired input variable when the power transfer device is operating. Thus, with the configuration described above, it is possible to determine whether an abnormality is caused in the endless rotary member of the power transfer device.

In the above aspect, the input variable may include the input rotational speed-related data; and the processor may be configured to acquire, as the chronological data on the input rotational speeds, a plurality of the input rotational speeds detected in each detection cycle in a predetermined measurement period, and generate the input rotational speed-related data based on data that indicate a distribution of a magnitude of numerical values of the plurality of the input rotational speeds included in the chronological data on the input rotational speeds.

A case where the chronological data on the input rotational speeds are used as an input variable for the mapping is considered. Also in this case, it is possible to determine whether an abnormality is caused in the endless rotary member based on the output variable that is output from the mapping. When such a determination is made, as the number of input rotational speeds included in the chronological data on the input rotational speeds is larger, the precision in determination is higher, but the amount of data on the input variables of the mapping is larger. With the configuration described above, in this respect, the input rotational speed-related data are generated based on data that indicate the distribution of the magnitude of the numerical values of the plurality of input rotational speeds included in the chronological data on the input rotational speeds. The input rotational speed-related data are adopted as an input variable for the mapping. In this case, even if the number of input rotational speeds included in the chronological data on the input rotational speeds is large, the volume of data that indicate the distribution of the magnitude of the numerical values of the plurality of input rotational speeds is not so large. Therefore, it is possible to suppress an increase in the amount of data on the input variables for the mapping without lowering the precision in determination.

In the above aspect, the input variable may include the input rotational speed-related data; and the processor may be configured to acquire, as the chronological data on the input rotational speeds, a plurality of the input rotational speeds detected in each detection cycle in a predetermined measurement period, normalize the plurality of the input rotational speeds included in the chronological data on the input rotational speeds, and generate, as the input rotational speed-related data, data that indicate a distribution of a magnitude of numerical values of a plurality of normalized input rotational speeds obtained by normalizing the input rotational speeds.

There is a difference between the chronological data on the input rotational speeds for a case where an abnormality is caused in the endless rotary member and the chronological data on the input rotational speeds for a case where an abnormality is not caused. However, the degree of the difference may be different between a case where the input rotational speed is high and a case where the input rotational speed is low. In a case where the chronological data on the input rotational speeds are used as an input variable for the mapping, the precision in determination tends to be low when the degree of the difference is relatively small, compared to that when the degree of the difference is relatively large. In other words, the precision in determination may be fluctuated, depending on the magnitude of the input rotational speeds at that time.

In the configuration described above, in this respect, the plurality of input rotational speeds included in the chronological data on the input rotational speeds are normalized. That is, a plurality of normalized input rotational speeds are generated. The input rotational speed-related data are generated based on data that indicate the distribution of the magnitude of the numerical values of the normalized input rotational speeds. Therefore, the degree of the difference between the input rotational speed-related data for a case where an abnormality is caused in the endless rotary member and the input rotational speed-related data for a case where an abnormality is not caused is not so different between a case where the input rotational speeds are high and a case where the input rotational speeds are low. As a result, it is possible to suppress fluctuations in the precision in determination due to variations in the input rotational speeds, by using the input rotational speed-related data as an input variable for the mapping.

Further, data that indicate the distribution of the magnitude of the numerical values of the normalized input rotational speeds, rather than the chronological data on the normalized input rotational speeds, are used as the input rotational speed-related data. Therefore, it is possible to suppress an increase in the amount of data on the input variables for the mapping without lowering the precision in determination.

In the above aspect, the output variable may include the output rotational speed-related data; and the processor may be configured to acquire, as the chronological data on the output rotational speeds, a plurality of the output rotational speeds detected in each detection cycle in a predetermined measurement period, and generate the output rotational speed-related data based on data that indicate a distribution of a magnitude of numerical values of the plurality of the output rotational speeds included in the chronological data on the output rotational speeds.

A case where the chronological data on the output rotational speeds are used as an input variable for the mapping is considered. Also in this case, it is possible to determine whether an abnormality is caused in the endless rotary member based on the output variable that is output from the mapping. When such a determination is made, as the number of output rotational speeds included in the chronological data on the output rotational speeds is larger, the precision in determination is higher, but the amount of data on the input variables of the mapping is larger. With the configuration described above, in this respect, the output rotational speed-related data are generated based on data that indicate the distribution of the magnitude of the numerical values of the plurality of output rotational speeds included in the chronological data on the output rotational speeds. The output rotational speed-related data are adopted as an input variable for the mapping. In this case, even if the number of output rotational speeds included in the chronological data on the output rotational speeds is large, the volume of data that indicate the distribution of the magnitude of the numerical values of the output rotational speeds is not so large. Therefore, it is possible to suppress an increase in the amount of data on the input variables for the mapping without lowering the precision in determination.

In the above aspect, the output variable may include the output rotational speed-related data; and the processor may be configured to acquire, as the chronological data on the output rotational speeds, a plurality of the output rotational speeds detected in each detection cycle in a predetermined measurement period, normalize the plurality of the output rotational speeds included in the chronological data on the output rotational speeds, and generate, as the output rotational speed-related data, data that indicate a distribution of a magnitude of numerical values of a plurality of normalized output rotational speeds obtained by normalizing the output rotational speeds.

There is a difference between the chronological data on the output rotational speeds for a case where an abnormality is caused in the endless rotary member and the chronological data on the output rotational speeds for a case where an abnormality is not caused. However, the degree of the difference may be different between a case where the output rotational speed is high and a case where the output rotational speed is low. When the chronological data on the output rotational speeds are used as an input variable for the mapping, the precision in determination tends to be low when the degree of the difference is relatively small, compared to that when the degree of the difference is relatively large. In other words, the precision in determination may be fluctuated, depending on the magnitude of the output rotational speeds at that time.

In the configuration described above, in this respect, the output rotational speeds included in the chronological data on the output rotational speeds are normalized. That is, a plurality of normalized output rotational speeds are generated. The output rotational speed-related data are generated based on data that indicate the distribution of the magnitude of the numerical values of the normalized output rotational speeds. Therefore, the degree of the difference between the output rotational speed-related data for a case where an abnormality is caused in the endless rotary member and the output rotational speed-related data for a case where an abnormality is not caused is not so different between a case where the output rotational speeds are high and a case where the output rotational speeds are low. As a result, it is possible to suppress fluctuations in the precision in determination due to variations in the output rotational speeds, by using the output rotational speed-related data as an input variable for the mapping.

Further, data that indicate the distribution of the magnitude of the numerical values of the normalized output rotational speeds, rather than the chronological data on the normalized output rotational speeds, are used as the output rotational speed-related data. Therefore, it is possible to suppress an increase in the amount of data on the input variables of the mapping without lowering the precision in determination.

In the above aspect, the input variable may include the input rotational speed-related data; and the processor may be configured to acquire, as the chronological data on the input rotational speeds, a plurality of the input rotational speeds detected in each detection cycle in a predetermined measurement period, derive frequency characteristics of the chronological data on the input rotational speeds by performing a fast Fourier transform on the chronological data, and generate the input rotational speed-related data based on the frequency characteristics of the chronological data.

With the configuration described above, the frequency characteristics of the chronological data on the input rotational speeds are derived by performing a fast Fourier transform on such chronological data. Then, the input rotational speed-related data are generated based on the frequency characteristics. There may be a difference between the input rotational speed-related data for a case where an abnormality in which the frequency characteristics of the chronological data may be varied is caused in the endless rotary member and the input rotational speed-related data generated when no such abnormality is caused. Therefore, when an abnormality that may characterize the frequency characteristics is caused in the endless rotary member, it is possible to determine that an abnormality is caused using the output variable that is output from the mapping upon receiving, as an input variable for the mapping, the input rotational speed-related data that are generated based on the frequency characteristics.

In the above aspect, the processor may be configured to: calculate an average value of the input rotational speeds during an acquisition period for the chronological data on the input rotational speeds; acquire, based on the average value of the input rotational speeds, an amplitude of a primary frequency of rotation of the endless rotary member; standardize, with the amplitude of the primary frequency of the rotation, the frequency characteristics of the input rotational speeds, the frequency characteristics being derived by performing the fast Fourier transform; and generate the input rotational speed-related data based on the standardized frequency characteristics of the input rotational speeds.

Even when an abnormality that may characterize the frequency characteristics of the chronological data on the input rotational speeds is caused in the endless rotary member, the magnitude of the characteristic amount of the abnormality in the frequency characteristics may be varied in accordance with the magnitude of the input rotational speeds. There may be fluctuations in the precision in determination of the occurrence of an abnormality between a case where the magnitude of the characteristic amount of the abnormality in the frequency characteristics is large and a case where the magnitude of the characteristic amount of the abnormality in the frequency characteristics is small.

With the configuration described above, the average value of the input rotational speeds during an acquisition period for the chronological data on the input rotational speeds is calculated. The amplitude of the primary frequency of rotation of the endless rotary member is acquired based on the average value. The frequency characteristics of the input rotational speeds, the frequency characteristics being derived through a fast Fourier transform, are standardized with the amplitude of the primary frequency of the rotation. The magnitude of the characteristic amount due to an abnormality that emerges in the thus standardized frequency characteristics of the input rotational speeds is not varied significantly between a case where the input rotational speeds are high and a case where the input rotational speeds are low. As a result, it is possible to suppress fluctuations in the precision in determination due to variations in the input rotational speeds, by using, as an input variable for the mapping, the input rotational speed-related data that are generated based on the frequency characteristics of the normalized input rotational speeds.

In the above aspect, the processor may be configured to generate the input rotational speed-related data by equally dividing frequency bands in which data derived by performing the fast Fourier transform on the chronological data on the input rotational speeds are distributed into a predetermined number of divisional frequency bands, and averaging the data for each of the divisional frequency bands.

With the configuration described above, the frequency band, in which data derived by performing a fast Fourier transform on the chronological data on the input rotational speeds are distributed, is divided into a predetermined number of frequency bands. The input rotational speed-related data are generated based on data averaged for each frequency band as described above. It is possible to suppress an increase in the number of data on the input variable of the mapping, by using, as an input variable for the mapping, the input rotational speed-related data that are generated by averaging data for each frequency band as described above.

In the above aspect, the input variable may include the output rotational speed-related data; and the processor may be configured to acquire, as the chronological data on the output rotational speeds, a plurality of the output rotational speeds detected in each detection cycle in a predetermined measurement period, derive frequency characteristics of the chronological data on the output rotational speeds by performing a fast Fourier transform on the chronological data, and generate the output rotational speed-related data based on the frequency characteristics of the chronological data.

With the configuration described above, the frequency characteristics of the chronological data on the output rotational speeds are derived by performing a fast Fourier transform on such chronological data. Then, the output rotational speed-related data are generated based on the frequency characteristics. There may be a difference between the output rotational speed-related data for a case where an abnormality in which the frequency characteristics of the chronological data may be varied is caused in the endless rotary member and the output rotational speed-related data that are based on the frequency characteristics of the chronological data for a case where no such abnormality is caused. Therefore, when an abnormality that may characterize the frequency characteristics is caused in the endless rotary member, it is possible to determine that an abnormality is caused using the output variable that is output from the vehicle, by using, as an input variable for the mapping, the output rotational speed-related data that are based on the frequency characteristics of the chronological data.

In the above aspect, the processor may be configured to: calculate an average value of the output rotational speeds during an acquisition period for the chronological data on the output rotational speeds; acquire, based on the average value of the output rotational speeds, an amplitude of a primary frequency of rotation of the endless rotary member; standardize, with the amplitude of the primary frequency of the rotation, the frequency characteristics of the output rotational speeds, the frequency characteristic being derived by performing the fast Fourier transform; and generate the output rotational speed-related data based on the standardized frequency characteristics of the output rotational speeds.

Even when an abnormality that may characterize the frequency characteristics of the chronological data on the output rotational speeds is caused in the endless rotary member, the magnitude of the characteristic amount of the abnormality in the frequency characteristics may be varied in accordance with the magnitude of the output rotational speeds. There may be fluctuations in the precision in detection of the occurrence of an abnormality between a case where the magnitude of the characteristic amount of the abnormality in the frequency characteristics is large and a case where the magnitude of the characteristic amount of the abnormality in the frequency characteristics is small.

With the configuration described above, the average value of the output rotational speeds during an acquisition period for the chronological data on the output rotational speeds is calculated. The amplitude of the primary frequency of rotation of the endless rotary member is acquired based on the average value. The frequency characteristics of the output rotational speeds, the frequency characteristics being derived through a fast Fourier transform, are standardized using the amplitude of the primary frequency of the rotation. The magnitude of the characteristic amount due to an abnormality that emerges in the thus standardized frequency characteristics of the output rotational speeds is not varied significantly between a case where the output rotational speeds are high and a case where the output rotational speeds are low. As a result, it is possible to suppress fluctuations in the precision in determination due to variations in the output rotational speeds, by using, as an input variable for the mapping, the output rotational speed-related data that are generated based on the frequency characteristics of the normalized output rotational speed.

In the above aspect, the processor may be configured to generate the output rotational speed-related data by equally dividing frequency bands in which data derived by performing the fast Fourier transform on the chronological data on the output rotational speeds are distributed into a predetermined number of divisional frequency bands, and averaging the data for each of the divisional frequency bands.

With the configuration described above, the frequency band, in which data derived by performing a fast Fourier transform on the chronological data on the output rotational speeds are distributed, is divided into a predetermined number of frequency bands. The output rotational speed-related data are generated based on data averaged for each frequency band as described above. It is possible to suppress an increase in the number of data on the input variable of the mapping, by using, as an input variable for the mapping, the output rotational speed-related data that are generated by averaging data for each frequency band as described above.

In the above aspect, the input variable may include at least one of torque input to the input pulley and a temperature of oil that circulates in the power transfer device. The magnitude and the period of vibration of the rotational speeds of the input pulley and the output pulley may be different between a case where torque input to the input pulley is large and a case where such torque is small. Thus, in the configuration described above, the torque input to the input pulley is used as an input variable for the mapping. That is, the output variable of the mapping has a value determined in consideration of the torque input to the input pulley. Therefore, the precision in determination can be enhanced by making the determination based on the output variable. The viscosity of oil is lower as the temperature of the oil is higher. The degree of slipping of the endless rotary member with respect to the input pulley and the output pulley tends to be larger as the viscosity of the oil is lower. The mode of vibration of the rotational speeds of the input pulley and the output pulley may be varied when the degree of slipping is different. Thus, in the configuration described above, the temperature of the oil is used as an input variable for the mapping. That is, the output variable that is output from the mapping has a value determined in consideration of the viscosity of the oil. Therefore, the precision in determination can be enhanced by making the determination based on the output variable.

In the above aspect, the memory may store at least one of an index that indicates a shape of the endless rotary member for each power transfer device, and an index that indicates a shape of a constituent part of the endless rotary member for each power transfer device; and the input variable may include the index stored in the memory.

Vibration components due to the shape of the endless rotary member and the shape of a constituent part of the endless rotary member may be superimposed on the rotational speeds of the input pulley and the output pulley. Such vibration components are not due to an abnormality caused in the endless rotary member. Thus, in the configuration described above, the memory stores at least one of an index that indicates the shape of the endless rotary member and an index that indicates the shape of the constituent part of the endless rotary member. The index stored in the memory is used as an input variable for the mapping. That is, the output variable that is output from the mapping has a value determined in consideration of at least one of the shape of the endless rotary member and the shape of the constituent part of the endless rotary member. Therefore, the precision in determination can be enhanced by making the determination based on the output variable.

In the above aspect, the input variable may include at least one of a force with which the input pulley holds the endless rotary member, and a force with which the output pulley holds the endless rotary member.

The degree of slipping caused between the input pulley and the endless rotary member may be varied in accordance with a force with which the input pulley holds the endless rotary member. In addition, the degree of slipping caused between the output pulley and the endless rotary member may be varied in accordance with a force with which the output pulley holds the endless rotary member. The mode of vibration of the rotational speeds of such pulleys may be varied when the degree of slipping caused between such pulleys and the endless rotary member is varied. Thus, in the configuration described above, at least one of a force with which the input pulley holds the endless rotary member and a force with which the output pulley holds the endless rotary member is used as an input variable for the mapping. That is, the output variable of the mapping has a value determined in consideration of at least one of the force with which the input pulley holds the endless rotary member and the force with which the output pulley holds the endless rotary member. Therefore, the precision in determination can be enhanced by making the determination based on the output variable.

In the above aspect, the memory may store an index that indicates an amount of backlash in a rotational direction of the endless rotary member for each power transfer device; and the input variable may include the index indicating the amount of backlash and stored in the memory.

When the amount of backlash in the rotational direction of the endless rotary member is large, vibration that matches the amount of backlash tends to be superimposed on rotation of the input pulley and the output pulley when the endless rotary member is rotating. Thus, in the configuration described above, the memory stores an index that indicates the amount of backlash in the rotational direction of the endless rotary member. The index indicating the amount of backlash and stored in the memory is used as an input variable for the mapping. That is, the output variable of the mapping has a value determined in consideration of the amount of backlash. The precision in determination can be enhanced by making the determination using the output variable.

In the above aspect, the input variable may include at least one of a detection value of an acceleration sensor mounted on the vehicle, a detection value of a sound sensor installed in an engine compartment of the vehicle, a braking force of the vehicle, a ratio between a rotational speed of the input pulley and a rotational speed of the output pulley, and an index that indicates a degree of temporal variations in characteristics of the endless rotary member. When an abnormality is caused in the endless rotary member, vibration due to the abnormality may be transmitted to the vehicle body, and a detection value of the in-vehicle acceleration sensor may be varied. Thus, in the configuration described above, the detection value of the acceleration sensor is used as an input variable for the mapping. That is, the output variable of the mapping has a value determined in consideration of the vibration of the vehicle body. Therefore, the precision in determination can be enhanced by making the determination based on the output variable. When an abnormality is caused in the endless rotary member and vibration due to the abnormality of the endless rotary member is superimposed on the rotational speeds of the input pulley and the output pulley, an abnormal sound due to the vibration may be generated in the power transfer device. Such an abnormal sound generated in the power transfer device can be detected by the sound sensor that is installed in the engine compartment. Thus, in the configuration described above, the detection value of the sound sensor is used as an input variable for the mapping. That is, the output variable of the mapping has a value determined in consideration of the sound detected by the sound sensor. Therefore, the precision in determination can be enhanced by making the determination based on the output variable. When a braking force of the vehicle is generated, the drive wheels are decelerated, and therefore the rotational speeds of the input pulley and the output pulley are also varied. In this event, vibration components due to the magnitude of the braking force or the speed of increase in the braking force may be superimposed on such rotational speeds. Thus, in the configuration described above, the braking force of the vehicle is used as an input variable for the mapping. That is, the output variable of the mapping has a value determined in consideration of the braking force of the vehicle. Therefore, the precision in determination can be enhanced by making the determination based on the output variable. When an abnormality is caused in the endless rotary member and therefore vibration is superimposed on the rotational speeds of the input pulley and the output pulley, the ratio between the rotational speed of the input pulley and the rotational speed of the output pulley may be different between a case where no abnormality is caused and a case where an abnormality is caused. Thus, in the configuration described above, the ratio between the rotational speeds is used as an input variable for the mapping. That is, the output variable of the mapping has a value determined in consideration of the ratio between the rotational speeds. Therefore, the precision in determination can be enhanced by making the determination based on the output variable. Even when an abnormality is not caused in the endless rotary member, the magnitude and the period of vibration of the rotational speeds of the input pulley and the output pulley may be varied between when the degree of temporal variations in the characteristics is relatively small and the degree of such temporal variations is relatively large. Thus, in the configuration described above, the index that indicates the degree of temporal variations in the characteristics is used as an input variable for the mapping. That is, the output variable of the mapping has a value determined in consideration of the degree of temporal variations in the characteristics. Therefore, the precision in determination can be enhanced by making the determination based on the output variable.

In the above aspect, the input variable may include the output rotational speed-related data; and the output rotational speeds may be calculated based on rotational speeds of the drive wheels. There is a correspondence between the rotational speed of the output pulley and the rotational speed of the drive wheels. Therefore, the value of the rotational speed of the output pulley can be calculated based on the rotational speed of the drive wheels. Data based on transitions in the calculated value of the rotational speed can be adopted as the output rotational speed-related data.

In the above aspect, the processor may be configured to determine, based on the output variable, whether a constituent part of the endless rotary member is damaged.

In a case where a constituent part of the endless rotary member is damaged, vibration is caused when the damaged portion contacts the input pulley or when the damaged portion contacts the output pulley. Such vibration emerges as vibration of the rotational speeds of the input pulley and the output pulley. Therefore, with the configuration described above, it is possible to determine that an abnormality is caused in the endless rotary member when the constituent part is damaged.

In the above aspect, the processor may be configured to: acquire the output variable corresponding to the input variable using the mapping data; and determine, based on the output variable, whether vibration that causes an in-vehicle part other than the power transfer device to resonate is generated in the endless rotary member.

With the configuration described above, it is possible to determine that the other in-vehicle part resonates because of vibration of the endless rotary member.

In the above aspect, the processor may be configured to: acquire the output variable corresponding to the input variable using the mapping data; and determine, based on the output variable, whether resonance is generated in the endless rotary member.

With the configuration described above, it is possible to determine that the endless rotary member resonates because of operation of the other in-vehicle device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a control device and a drive system of a vehicle controlled by the control device according to a first embodiment;

FIG. 2 is a schematic view illustrating how a belt is held between pulleys;

FIG. 3 is a schematic view illustrating a part of the belt;

FIG. 4 illustrates the former half of a flowchart illustrating a sequence of processes executed by the control device;

FIG. 5 illustrates the latter half of the flowchart illustrating the sequence of processes executed by the control device;

FIG. 6 is a time chart illustrating transitions in input rotational speeds or output rotational speeds;

FIG. 7 is a time chart illustrating transitions in the input rotational speeds or the output rotational speeds;

FIG. 8 is a graph illustrating input rotational speed-related data or output rotational speed-related data represented in a histogram;

FIG. 9 is a graph illustrating the input rotational speed-related data or the output rotational speed-related data represented in a histogram;

FIG. 10 is a flowchart illustrating a part of a sequence of processes executed by a control device according to a second embodiment; and

FIG. 11 is a flowchart illustrating a part of a sequence of processes executed by a control device according to a third embodiment.

### DETAILED DESCRIPTION OF EMBODIMENTS

### First Embodiment

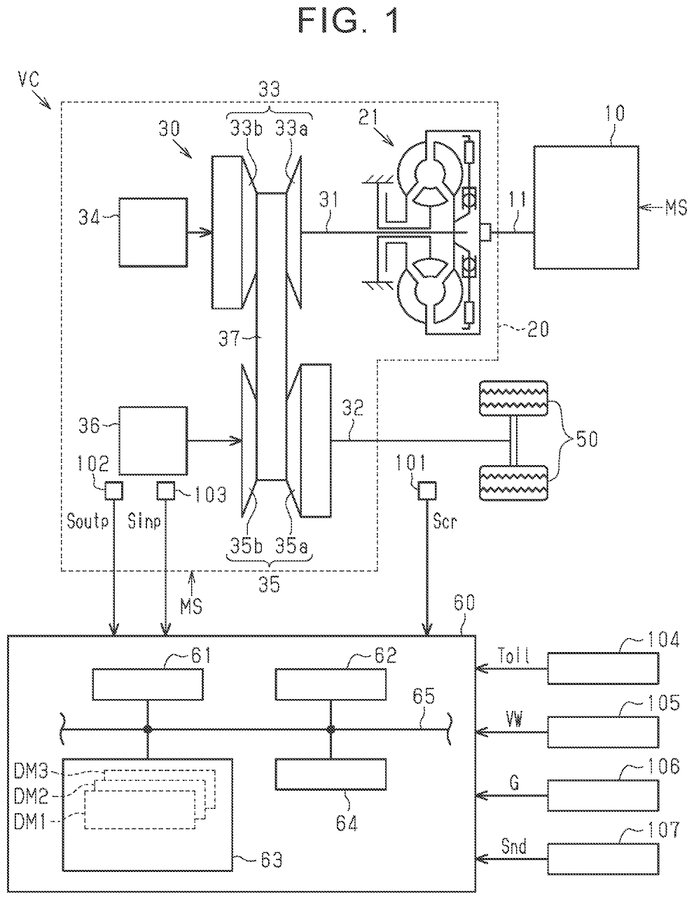

An abnormality determination device for a power transfer device according to a first embodiment will be described below with reference to FIGS. 1 to 9.

As illustrated in FIG. 1, a vehicle VC includes an internal combustion engine 10, a speed change device 20, and drive wheels 50. A torque converter 21 of the speed change device 20 is coupled to a crankshaft 11 of the internal combustion engine 10. An input shaft 31 of a speed change mechanism 30 is coupled to the torque converter 21. A plurality of drive wheels 50 is coupled to an output shaft 32 of the speed change mechanism 30 via a differential (not illustrated).

The speed change mechanism 30 has an input pulley 33, an output pulley 35, and a belt 37 wound around the input pulley 33 and the output pulley 35. Output torque of the internal combustion engine 10 is input to the input pulley 33 via the torque converter 21. The output pulley 35 outputs torque toward the drive wheels 50 via the output shaft 32.

The input pulley 33 has a fixed sheave 33a to which the input shaft 31 is coupled, and a movable sheave 33b. That is, the fixed sheave 33a and the movable sheave 33b hold the belt 37 therebetween. The movable sheave 33b is movable away from and closer to the fixed sheave 33a. Such operation of the movable sheave 33b is achieved by driving an input actuator 34. The input actuator 34 may be electrically driven, or may be hydraulically driven.

The output pulley 35 has a fixed sheave 35a to which the output shaft 32 is coupled, and a movable sheave 35b. That is, the fixed sheave 35a and the movable sheave 35b hold the belt 37 therebetween. The movable sheave 35b is movable away from and closer to the fixed sheave 35a. Such operation of the movable sheave 35b is achieved by driving an output actuator 36. The output actuator 36 may be electrically driven, or may be hydraulically driven.

The gear ratio of the speed change mechanism 30 is controlled by adjusting the position of the movable sheave 33b relative to the fixed sheave 33a of the input pulley 33 and the position of the movable sheave 35b relative to the fixed sheave 35a of the output pulley 35.

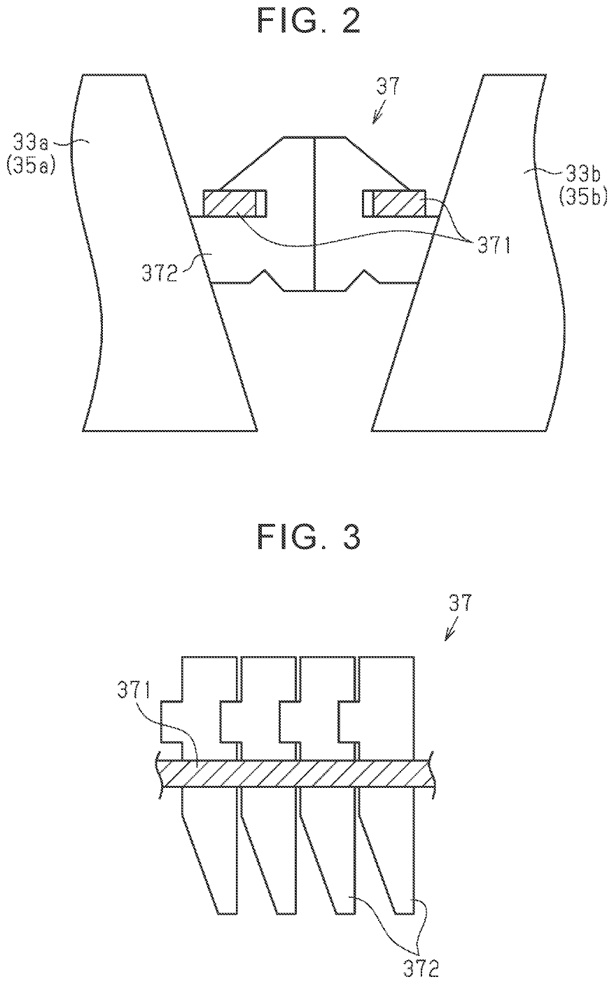

As illustrated in FIGS. 2 and 3, the belt 37 has endless rings 371 and a large number of elements 372 supported on the rings 371. The elements 372 are arranged along the rotational direction of the belt 37.

A control device 60 illustrated in FIG. 1 controls the internal combustion engine 10, and operates various operation portions of the internal combustion engine 10 in order to control torque, the exhaust component proportion, etc. as controlled variables. The control device 60 also controls the speed change device 20, and operates the input actuator 34 and the output actuator 36.

To control the above controlled variables, the control device 60 references an output signal Scr from a crank angle sensor 101, an output signal Sinp from an input shaft rotational angle sensor 102 that detects the rotational angle of the input shaft 31, and an output signal Soutp from an output shaft rotational angle sensor 103 that detects the rotational angle of the output shaft 32. In addition, the control device 60 references an oil temperature detection value Toil that is the temperature of oil detected by an oil temperature sensor 104, a wheel speed VW that is the rotational speed of the drive wheels 50 and that is detected by a wheel speed sensor 105, a vehicle acceleration G that is the acceleration of the vehicle VC and that is detected by an acceleration sensor 106, and a sound detection value Snd that is the volume of a sound and that is detected by a sound sensor 107.

The oil temperature sensor 104 detects the temperature of oil that circulates in the speed change mechanism 30. The sound sensor 107 is installed in an engine compartment of the vehicle VC, for example. Therefore, the sound detection value Snd represents the volume of a sound in the engine compartment.

The control device 60 includes a central processing unit (CPU) 61, a read only memory (ROM) 62, a memory 63 that is an electrically rewritable non-volatile memory, and a peripheral circuit 64. These components are communicable with each other via a local network 65. The peripheral circuit 64 includes a circuit that generates a clock signal that prescribes internal operation, a power source circuit, a reset circuit, etc. The control device 60 controls the various controlled variables by the CPU 61 executing a program stored in the ROM 62.

The memory 63 stores a plurality of mapping data DM1, DM2, and DM3. The mapping data DM1, DM2, and DM3 include data that prescribe mapping that outputs, upon receiving input of various input variables to be discussed later, an output variable corresponding to the input variable, the data being learned through machine learning.

The memory 63 also stores a belt shape index MVs that is an index indicating the shape of the belt 37 for each speed change device 20, and an element shape index MVEs that is an index indicating the shape of the elements 372 for each speed change device 20. The belt shape index MVs and the element shape index MVEs are values measured at the shipping stage of the vehicle VC or at the time of inspection at the shipping stage of the speed change device 20, for example. Examples of the belt shape index MVs include the length in the rotational direction of the belt 37 and an error between an actually measured value and the design value of the length in the rotational direction of the belt 37. Examples of the element shape index MVEs include the average value of measured values of the thickness of all the elements 372 and the average value of measured values of the width of all the elements 372. Other examples of the element shape index MVEs include an error between the average value of measured values of the thickness of all the elements 372 and the design value of the thickness of the elements 372 and an error between the average value of measured values of the width of all the elements 372 and an actually measured value of the width of the elements 372.

The memory 63 also stores a backlash amount index MVRa that is an index indicating the amount of backlash of the elements 372 in the rotational direction for each speed change device 20. The backlash amount index MVRa is a value measured at the shipping stage of the vehicle VC or at the time of inspection at the shipping stage of the speed change device 20, for example. Examples of the backlash amount index MVRa include the average value of the clearances between elements 372 that are adjacent to each other in the rotational direction.

Vibration is occasionally generated in the vehicle VC during operation of the speed change device 20. Examples of the factor of vibration that may be generated in the vehicle VC because of operation of the speed change device 20 include the following:
Damage to a constituent part of the belt 37
Resonance generated in in-vehicle devices other than the speed change device 20 because of operation of the speed change device 20
Resonance generated in the speed change mechanism 30 because of operation of in-vehicle devices other than the speed change device 20

For example, when one of the elements 372 is damaged, vibration is generated at the input pulley 33 each time the damaged element 372 contacts the input pulley 33. As a result, vibration due to vibration of the input pulley 33 is superimposed on input rotational speeds Ninp that are detection values of the rotational speeds of the input pulley 33. In addition, vibration is generated at the output pulley 35 each time the damaged element 372 contacts the output pulley 35. As a result, vibration due to vibration of the output pulley 35 is superimposed on output rotational speeds Noutp that are detection values of the rotational speeds of the output pulley 35.

That is, transitions in the input rotational speeds Ninp and the output rotational speeds Noutp for a case where an abnormality due to damage to the belt 37 is caused in the belt 37 in this manner differ from those for a case where no abnormality is caused in the belt 37. Thus, in the present embodiment, the control device 60 determines whether an abnormality is caused in the belt 37 based on transitions in the input rotational speeds Ninp and the output rotational speeds Noutp. In this event, the control device 60 uses the mapping data DM1 that are stored in the memory 63.

Other in-vehicle devices are also installed in the engine compartment in which the speed change device 20 is installed. Resonance is occasionally generated in the belt 37 of the speed change device 20, depending on the period of vibration generated in the other in-vehicle devices. Meanwhile, resonance is occasionally generated in the other in-vehicle devices, depending on the period of vibration generated in the speed change device 20. In order to suppress generation of such resonance, the internal combustion engine 10 and the speed change device 20 are preferably controlled such that the operation point of the speed change mechanism 30 is offset from an operation point of the speed change mechanism 30 at which resonance is generated in the speed change device 20 and an operation point of the speed change mechanism 30 at which resonance is generated in the other in-vehicle devices.

Thus, in the present embodiment, the control device 60 determines whether resonance is generated in the other in-vehicle devices because of operation of the speed change device 20 based on transitions in the input rotational speeds Ninp and the output rotational speeds Noutp. In this event, the control device 60 uses the mapping data DM2 that are stored in the memory 63. In addition, the control device 60 determines whether resonance is generated in the belt 37 because of operation of the other in-vehicle devices based on transitions in the input rotational speeds Ninp and the output rotational speeds Noutp. In this event, the control device 60 uses the mapping data DM3 that are stored in the memory 63.

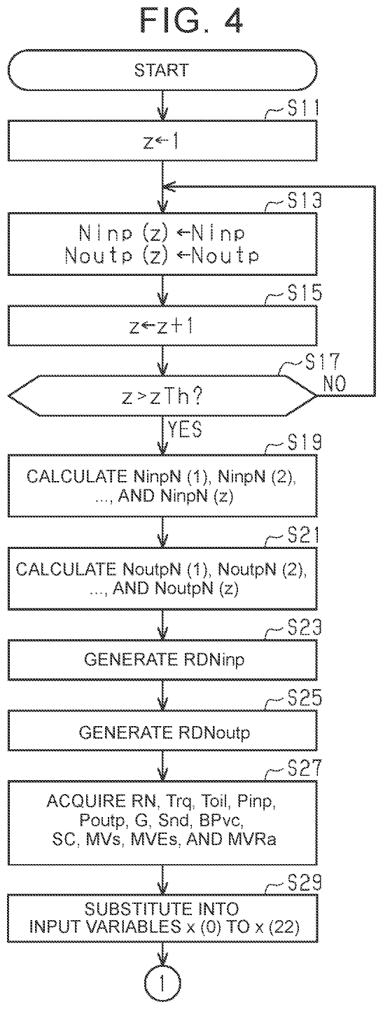

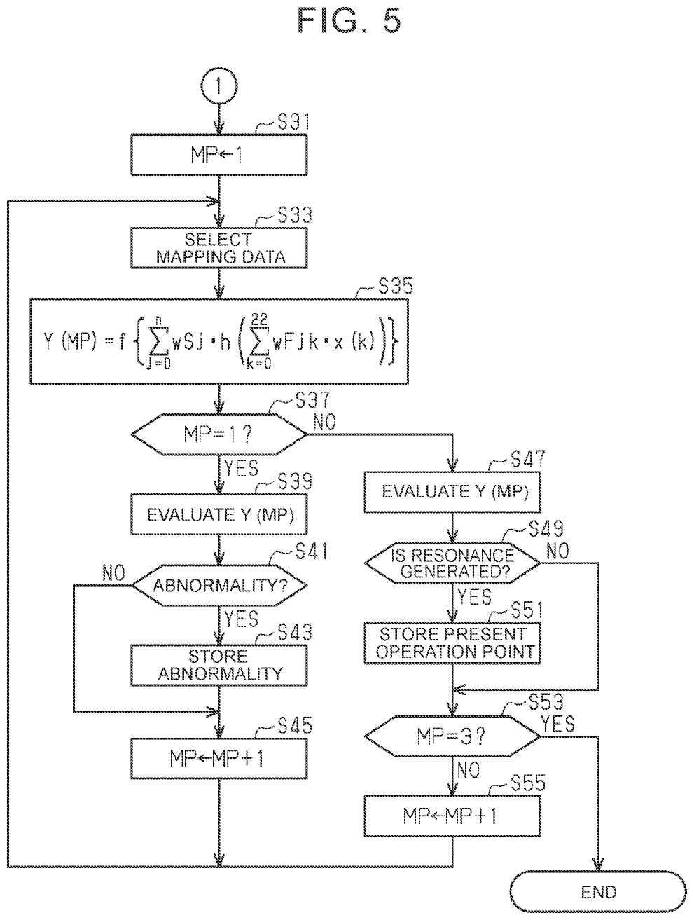

The procedures of a sequence of processes executed by the control device 60 in order to make various determinations as described above will be described with reference to FIGS. 4 and 5. The flow of the sequence of processes illustrated in FIGS. 4 and 5 is implemented by the CPU 61 executing a program stored in the ROM 62. The sequence of processes is executed repeatedly at predetermined periods. That is, the CPU 61 starts execution of the sequence of processes again when a time elapsed from the time when the sequence of processes is once ended reaches a time corresponding to the predetermined periods.

First, in step S11, the CPU 61 sets a coefficient z to “1”. In the next step S13, the CPU 61 acquires the present input rotational speed Ninp as the input rotational speed Ninp (z). The CPU 61 also acquires the present output rotational speed Noutp as the output rotational speed Noutp (z). In the next step S15, the CPU 61 increments the coefficient z by “1”.

Subsequently, in step S17, the CPU 61 determines whether the coefficient z is more than a coefficient determination value zTh. In the present embodiment, in order to make the above determination, chronological data on the input rotational speeds Ninp and chronological data on the output rotational speeds Noutp are used. The chronological data on the input rotational speeds Ninp include a plurality of input rotational speeds Ninp that are consecutive chronologically. The chronological data on the output rotational speeds Noutp include a plurality of output rotational speeds Noutp that are consecutive chronologically. The coefficient determination value zTh is set as a determination criterion as to whether the number of input rotational speeds Ninp and the number of output rotational speeds Noutp required for the above determination have been acquired. When the coefficient z is equal to or less than the coefficient determination value zTh (S17: NO), the CPU 61 proceeds to the process in step S13. That is, the input rotational speeds Ninp and the output rotational speeds Noutp are continuously acquired. When the coefficient z is more than the coefficient determination value zTh (S17: YES), on the other hand, chronological data on the input rotational speeds Ninp composed of “z” input rotational speeds Ninp and chronological data on the output rotational speeds Noutp composed of “z” output rotational speeds Noutp have been acquired, and therefore the CPU 61 proceeds to the process in the next step S19.

In step S19, the CPU 61 normalizes the chronological data on the input rotational speed Ninp. For example, the CPU 61 determines, as a reference input rotational speed NinpB, a value that is the largest among the plurality of input rotational speeds Ninp (1), Ninp (2), . . . , and Ninp (z) that are included in the chronological data on the input rotational speeds Ninp. Subsequently, the CPU 61 normalizes the input rotational speeds Ninp (1), Ninp (2), . . . , and Ninp (z) by dividing the input rotational speeds Ninp (1), Ninp (2), . . . , and Ninp (z) by the reference input rotational speed NinpB. The input rotational speeds Ninp (1), Ninp (2), . . . , and Ninp (z) that have been normalized are referred to as normalized input rotational speeds NinpN (1), NinpN (2), . . . , and NinpN (z). For example, the normalized input rotational speed NinpN (1) has a value obtained by dividing the input rotational speed Ninp (1) by the reference input rotational speed NinpB. Data including the normalized input rotational speeds NinpN (1), NinpN (2), . . . , and NinpN (z) are also referred to as “chronological data on the normalized input rotational speeds NinpN”.

In step S21, the CPU 61 normalizes the chronological data on the output rotational speeds Noutp. For example, the CPU 61 determines, as a reference output rotational speed NoutpB, a value that is the largest among the plurality of output rotational speeds Noutp (1), Noutp (2), . . . , and Noutp (z) that are included in the chronological data on the output rotational speeds Noutp. Subsequently, the CPU 61 normalizes the output rotational speeds Noutp (1), Noutp (2), . . . , and Noutp (z) by dividing the output rotational speeds Noutp (1), Noutp (2), . . . , and Noutp (z) by the reference output rotational speed NoutpB. The output rotational speeds Noutp (1), Noutp (2), . . . , and Noutp (z) that have been normalized are referred to as normalized output rotational speeds NoutpN (1), NoutpN (2), . . . , and NoutpN (z). For example, the normalized output rotational speed NoutpN (1) has a value obtained by dividing the output rotational speed Noutp (1) by the reference output rotational speed NoutpB. Data including the normalized output rotational speeds NoutpN (1), NoutpN (2), . . . , and NoutpN (z) are also referred to as “chronological data on the normalized output rotational speeds NoutpN”.

In the next step S23, the CPU 61 generates input rotational speed-related data RDNinp based on the chronological data on the normalized input rotational speeds NinpN. In the present embodiment, the normalized input rotational speeds NinpN (1), NinpN (2), . . . , and NinpN (z) are more than “0” and equal to or less than “1”. Thus, the region of numerical values from “0” to “1” is divided into a plurality of regions. For example, the region of numerical values from “0” to “1” is divided for every “0.2”. The CPU 61 counts, for each divided region, the number of normalized input rotational speeds NinpN included in the divided region. For example, when there are “four” normalized input rotational speeds NinpN that are more than “0.4” and equal to or less than “0.6” among the normalized input rotational speeds NinpN (1), NinpN (2), . . . , and NinpN (z), the CPU 61 determines the number of normalized input rotational speeds NinpN included in the divided region from “0.4” to “0.6” as “4”. The CPU 61 derives the result of the counting for each divided region as the input rotational speed-related data RDNinp. That is, the input rotational speed-related data RDNinp are data indicating the distribution of the magnitude of the numerical values of the plurality of normalized input rotational speeds NinpN (1), NinpN (2), . . . , and NinpN (z) that are included in the chronological data on the normalized input rotational speeds NinpN.

In the next step S25, the CPU 61 generates output rotational speed-related data RDNoutp based on the chronological data on the normalized output rotational speeds NoutpN. In the present embodiment, the normalized output rotational speeds NoutpN (1), NoutpN (2), . . . , and NoutpN (z) are more than “0” and equal to or less than “1”. Thus, the region of numerical values from “0” to “1” is divided into a plurality of regions. For example, the region of numerical values from “0” to “1” is divided for every “0.2”. The CPU 61 counts, for each divided region, the number of normalized output rotational speeds NoutpN included in the divided region. For example, when there are “two” normalized output rotational speeds NoutpN that are more than “0.4” and equal to or less than “0.6” among the normalized output rotational speeds NoutpN (1), NoutpN (2), . . . , and NoutpN (z), the CPU 61 determines the number of normalized output rotational speeds NoutpN included in the divided region from “0.4” to “0.6” as “2”. The CPU 61 derives the result of the counting for each divided region as the output rotational speed-related data RDNoutp. That is, the output rotational speed-related data RDNoutp are data indicating the distribution of the magnitude of the numerical values of the plurality of normalized output rotational speeds NoutpN (1), NoutpN (2), . . . , and NoutpN (z) that are included in the chronological data on the normalized output rotational speeds NoutpN.

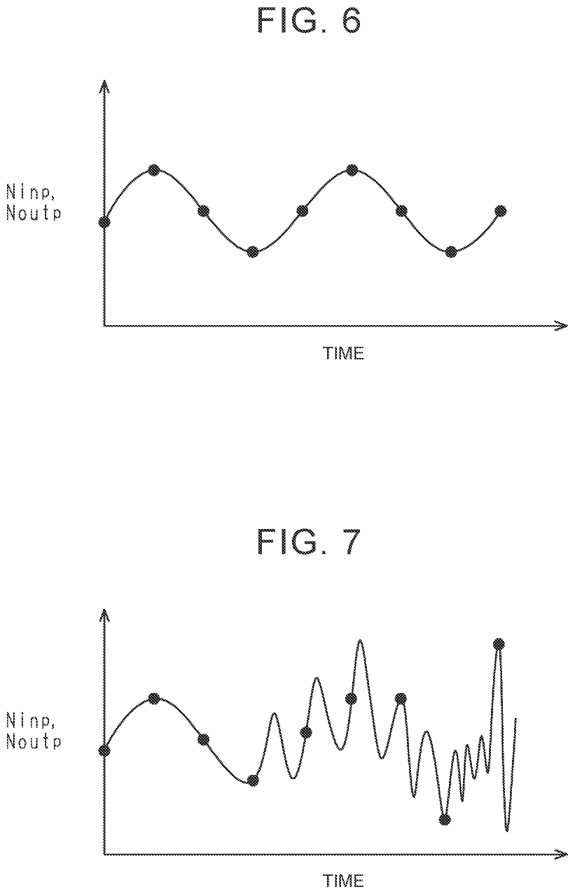

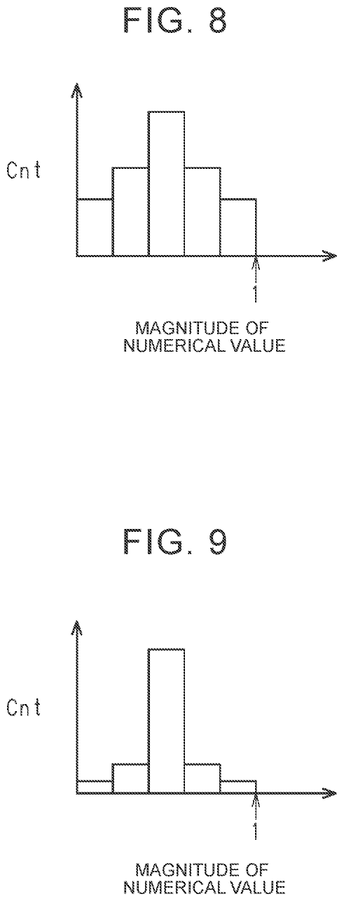

FIGS. 6 and 7 each illustrate chronological data on the input rotational speeds Ninp. The chronological data on the input rotational speeds Ninp illustrated in FIG. 6 are data for a case where the gear ratio of the speed change mechanism 30 is constant and the vibration discussed above is not generated. The chronological data on the input rotational speeds Ninp illustrated in FIG. 7 are data for a case where the gear ratio of the speed change mechanism 30 is constant and the vibration discussed above is superimposed on the input rotational speeds Ninp. FIG. 8 illustrates the input rotational speed-related data RDNinp represented in a histogram. The input rotational speed-related data RDNinp are generated based on the chronological data on the input rotational speeds Ninp illustrated in FIG. 6. FIG. 9 illustrates the input rotational speed-related data RDNinp represented in a histogram. The input rotational speed-related data RDNinp are generated based on the chronological data on the input rotational speeds Ninp illustrated in FIG. 7. There is a difference in the fluctuations among count values Cnt (1) to Cnt (5) between the input rotational speed-related data RDNinp illustrated in FIG. 8 and the input rotational speed-related data RDNinp illustrated in FIG. 9. That is, it is possible to determine whether an abnormality is caused based on the fluctuations among the count values Cnt (1) to Cnt (5) in the input rotational speed-related data RDNinp.

When the input rotational speeds Ninp are replaced with the output rotational speeds Noutp in FIGS. 6 and 7, FIGS. 6 and 7 are considered to illustrate chronological data on the output rotational speeds Noutp. In this case, FIG. 8 is considered to illustrate the output rotational speed-related data RDNoutp represented in a histogram. The output t rotational speed-related data RDNoutp are generated based on the chronological data on the output rotational speeds Noutp illustrated in FIG. 6. FIG. 9 is considered to illustrate the output rotational speed-related data RDNoutp represented in a histogram. The output rotational speed-related data RDNoutp are generated based on the chronological data on the output rotational speed Noutp illustrated in FIG. 7. There is a difference in the fluctuations among count values Cnt (1) to Cnt (5) between the output rotational speed-related data RDNoutp illustrated in FIG. 8 and the output rotational speed-related data RDNoutp illustrated in FIG. 9. That is, it is possible to determine whether an abnormality is caused based on the fluctuations among the count values Cnt (1) to Cnt (5) in the output rotational speed-related data RDNoutp.

Returning to FIGS. 4 and 5, when the process in step S25 is finished, the CPU 61 acquires the other data in the next step S27. The other data include a rotational speed ratio RN, input torque Trq, the oil temperature detection value Toil, an input engagement force Pinp, an output engagement force Poutp, the vehicle acceleration G, the sound detection value Snd, a braking force BPvc of the vehicle VC, and a travel distance SC of the vehicle VC. The CPU 61 acquires the indexes MVs, MVEs, and MVRa stored in the memory 63.

The rotational speed ratio RN is a value obtained by dividing the present output rotational speed Noutp by the present input rotational speed Ninp. The input torque Trq is torque input to the input pulley 33. The input torque Trq can be derived based on output torque from the internal combustion engine 10 and the torque transfer efficiency of the torque converter 21. The input engagement force Pinp is an engagement force of the input pulley 33 for the belt 37, that is, a force with which the input pulley 33 holds the belt 37. The input engagement force Pinp is larger as a drive force input from the input actuator 34 to the movable sheave 33b is larger. The output engagement force Poutp is an engagement force of the output pulley 35 for the belt 37, that is, a force with which the output pulley 35 holds the belt 37. The output engagement force Poutp is larger as a drive force input from the output actuator 36 to the movable sheave 35b is larger. The braking force BPvc is derived based on a required value of a braking force due to a braking operation by the driver etc. The travel distance SC is an index that indicates the degree of temporal variations in the characteristics of the belt 37.

In the next step S29, the CPU 61 substitutes, into the input variables x (1) to x (22) for the mapping that is prescribed by the mapping data, the input rotational speed-related data RDNinp generated in step S23, the output rotational speed-related data RDNoutp generated in step S25, and the various data acquired in step S27. That is, the CPU 61 substitutes the count value Cnt (1) of the input rotational speed-related data RDNinp into the input variable x (1), the count value Cnt (2) into the input variable x (2), the count value Cnt (3) into the input variable x (3), the count value Cnt (4) into the input variable x (4), and the count value Cnt (5) into the input variable x (5). The CPU 61 also substitutes the count value Cnt (1) of the output rotational speed-related data RDNoutp into the input variable x (6), the count value Cnt (2) into the input variable x (7), the count value Cnt (3) into the input variable x (8), the count value Cnt (4) into the input variable x (9), and the count value Cnt (5) into the input variable x (10). The CPU 61 also substitutes the rotational speed ratio RN into the input variable x (11), the input torque Trq into the input variable x (12), the oil temperature detection value Toil into the input variable x (13), the input engagement force Pinp into the input variable x (14), and the output engagement force Poutp into the input variable x (15). The CPU 61 also substitutes the vehicle acceleration G into the input variable x (16), the sound detection value Snd into the input variable x (17), the braking force BPvc into the input variable x (18), and the travel distance SC into the input variable x (19). The CPU 61 also substitutes the belt shape index MVs into the input variable x (20), the element shape index MVEs into the input variable x (21), and the backlash amount index MVRa into the input variable x (22).

In the next step S31, as illustrated in FIG. 5, the CPU 61 sets the determination coefficient MP to “1”. In the next step S33, the CPU 61 selects mapping data that match the determination coefficient MP from among the mapping data DM1, DM2, and DM3 that are stored in the memory 63. For example, the CPU 61 selects the mapping data DM1 when the determination coefficient MP is set to “1”, selects the mapping data DM2 when the determination coefficient MP is set to “2”, and selects the mapping data DM3 when the determination coefficient MP is set to “3”.

Then, in step S35, the CPU 61 calculates an output variable Y (MP) by inputting the input variables x (1) to x (22) to the mapping that is prescribed by the selected mapping data.

In the present embodiment, the mapping is constituted as a fully-connected forward-propagation neural network with a single intermediate layer. The neural network includes an input-side coefficient wFjk (j=0 to n, k=0 to 22) and an activation function h (x) as input-side non-linear mapping that performs a non-linear transform on each output of input-side linear mapping that is linear mapping prescribed by the input-side coefficient wFjk. In the present embodiment, a hyperbolic tangent “tanh (x)” is indicated as an example of the activation function h (x). The neural network also includes an output-side coefficient wSj (j=0 to n) and an activation function f (x) as output-side non-linear mapping that performs a non-linear transform on each output of output-side linear mapping that is linear mapping prescribed by the output-side coefficient wSj. In the present embodiment, a hyperbolic tangent “tanh (x)” is indicated as an example of the activation function f (x). A value n indicates the dimension of the intermediate layer. In the present embodiment, the value n is less than “22” that is the dimension of the input variables x. The input-side coefficient wFj0 is a bias parameter, and is a coefficient of the input variable x (0). The input variable x (0) is defined as “1”. The output-side coefficient wS0 is a bias parameter.

The mapping data DM1 are a trained model trained using a vehicle of the same specifications as those of the vehicle VC before being mounted on the vehicle VC. To train the mapping data DM1, training data composed of teacher data and input data are acquired beforehand. That is, the chronological data on the input rotational speeds Ninp and the chronological data on the output rotational speeds Noutp are acquired when the vehicle is caused to actually travel. The input rotational speed-related data RDNinp are acquired as the input data by performing processes that are similar to those in steps S19 and S23 on the chronological data on the input rotational speeds Ninp. Likewise, the output rotational speed-related data RDNoutp are acquired as the input data by performing processes that are similar to those in steps S21 and S25 on the chronological data on the output rotational speeds Noutp. At this time, in addition, the rotational speed ratio RN, the input torque Trq, the oil temperature detection value Toil, the input engagement force Pinp, the output engagement force Poutp, the vehicle acceleration G, the sound detection value Snd, the braking force BPvc, and the travel distance SC are also acquired as the input data. Further, abnormality occurrence information that indicates whether an abnormality is caused in the belt 37 is acquired as the teacher data. For example, the abnormality occurrence information may be set to “0” when an abnormality is caused, and the abnormality occurrence information may be set to “1” when an abnormality is not caused. The indexes MVs, MVEs, and MVRa are also acquired as the input data before the vehicle is caused to travel.

A plurality of training data are generated by causing the vehicle to travel under various circumstances. For example, the speed change mechanism 30 in which one of the elements 372 of the belt 37 is intentionally damaged is mounted on the vehicle, and the vehicle is caused to travel. In this case, various input data for a case where an abnormality is caused in the belt 37 can be acquired, and abnormality occurrence information indicating that an abnormality is caused can be acquired as the teacher data. Meanwhile, the speed change mechanism 30 in which none of the elements 372 of the belt 37 is damaged is mounted on the vehicle, and the vehicle is caused to travel. In this case, various input data for a case where an abnormality is not caused in the belt 37 can be acquired, and abnormality occurrence information indicating that an abnormality is not caused can be acquired as the teacher data.

The mapping data DM1 are trained using a plurality of training data. That is, input-side variables and an output-side variable are adjusted such that an error between the output variable that is output from the mapping using input of the input data and the actual abnormality occurrence information converges to a predetermined value or less.

Likewise, the mapping data DM2 are a trained model trained using a vehicle of the same specifications as those of the vehicle VC before being mounted on the vehicle VC. To train the mapping data DM2, training data composed of teacher data and input data are also acquired beforehand. That is, various input data are acquired as described above by causing the vehicle to actually travel while changing the operation point of the speed change device 20. In this event, in addition, first resonance generation information that indicates whether resonance is generated in in-vehicle devices other than the speed change device 20 is acquired as the teacher data. For example, the first resonance generation information may be set to “0” when resonance is generated in the other in-vehicle devices, and the first resonance generation information may be set to “1” when resonance is not generated in the other in-vehicle devices.

A plurality of training data composed of teacher data and input data are generated by causing the vehicle to travel under various circumstances. The mapping data DM2 are trained using the training data. That is, input-side variables and an output-side variable are adjusted such that an error between the output variable that is output from the mapping using input of the input data and the actual first resonance generation information converges to a predetermined value or less.

Likewise, the mapping data DM3 are a trained model trained using a vehicle of the same specifications as those of the vehicle VC before being mounted on the vehicle VC. To train the mapping data DM3, training data composed of teacher data and input data are also acquired beforehand. That is, various input data are acquired as described above by causing the vehicle to actually travel while changing the operation point of the speed change device 20. In this event, in addition, second resonance generation information that indicates whether resonance is generated in the belt 37 is acquired as the teacher data. For example, the second resonance generation information may be set to “0” when resonance is generated in the belt 37, and the second resonance generation information may be set to “1” when resonance is not generated in the belt 37.

A plurality of training data composed of teacher data and input data are generated by causing the vehicle to travel under various circumstances. The mapping data DM3 are trained using the training data. That is, input-side variables and an output-side variable are adjusted such that an error between the output variable that is output from the mapping using input of the input data and the actual second resonance generation information converges to a predetermined value or less.

When the output variable Y (MP) is calculated in step S35, the CPU 61 determines whether the determination coefficient MP is set to “1” in the next step S37. When the determination coefficient MP is set to “1” (S37: YES), the CPU 61 proceeds to the process in step S39. In step S39, the CPU 61 evaluates the output variable Y (1) calculated in step S35. That is, the CPU 61 determines whether an abnormality is caused in the belt 37 based on the output variable Y (1). For example, the CPU 61 determines that an abnormality is caused when the output variable Y (1) is equal to or less than an abnormality determination value. On the other hand, the CPU 61 does not determine that an abnormality is caused when the output variable Y (1) is more than the abnormality determination value. The abnormality determination value is set to a value that is more than “0” and less than “1”. For example, the abnormality determination value may be set to “0.5”.

In the next step S41, the CPU 61 determines whether an abnormality is caused in the belt 37 based on the result of evaluating the output variable Y (1) in step S39. When it is determined that an abnormality is caused (S41: YES), the CPU 61 proceeds to the process in the next step S43. The CPU 61 causes the memory 63 to store information indicating that an abnormality is caused in the belt 37 in step S43, and thereafter proceeds to the process in the next step S45. When it is not determined in step S41 that an abnormality is caused in the belt 37 (NO), the CPU 61 proceeds to the process in the next step S45.

In step S45, the CPU 61 increments the determination coefficient MP by “1”. After that, the CPU 61 proceeds to the process in step S33. When the determination coefficient MP is not set to “1” in step S37 (NO), on the other hand, the CPU 61 proceeds to the process in the next step S47. In step S47, the CPU 61 evaluates the output variable Y (MP). That is, when the determination coefficient MP is set to “2”, the CPU 61 determines, based on the output variable Y (2), whether resonance is generated in the other in-vehicle devices because of vibration of the belt 37. For example, when the output variable Y (2) is equal to or less than a first resonance determination value, the CPU 61 determines that resonance is generated in the other in-vehicle devices because of vibration of the belt 37. When the output variable Y (2) is more than the first resonance determination value, on the other hand, the CPU 61 does not determine that resonance is generated in the other in-vehicle devices because of vibration of the belt 37. The first resonance determination value is set to a value that is more than “0” and less than “1”. For example, the first resonance determination value may be set to “0.5”.

When the determination coefficient MP is set to “3”, meanwhile, the CPU 61 determines, based on the output variable Y (3), whether resonance is generated in the belt 37 because of vibration of the other in-vehicle devices. For example, when the output variable Y (3) is equal to or less than a second resonance determination value, the CPU 61 determines that resonance is generated in the belt 37 because of vibration of the other in-vehicle devices. When the output variable Y (3) is more than the second resonance determination value, on the other hand, the CPU 61 does not determine that resonance is generated in the belt 37 because of vibration of the other in-vehicle devices. The second resonance determination value is set to a value that is more than “0” and less than “1”. For example, the second resonance determination value may be set to “0.5”.

Subsequently, in step S49, the CPU 61 determines whether resonance is generated based on the result of evaluating the output variable Y (MP) in step S47. That is, when the determination coefficient MP is set to “2”, the CPU 61 determines whether resonance is generated in the other in-vehicle devices because of vibration of the belt 37. When it is determined that resonance is generated in the other in-vehicle devices because of vibration of the belt 37 (S49: YES), the CPU 61 proceeds to the process in step S51. When it is not determined that resonance is generated in the other in-vehicle devices because of vibration of the belt 37 (S49: NO), on the other hand, the CPU 61 proceeds to the process in step S53. When the determination coefficient MP is set to “3”, meanwhile, the CPU 61 determines whether resonance is generated in the belt 37 because of operation of the other in-vehicle devices. When it is determined that resonance is generated in the belt 37 because of operation of the other in-vehicle devices (S49: YES), the CPU 61 proceeds to the process in step S51. When it is not determined that resonance is generated in the belt 37 because of operation of the other in-vehicle devices (S49: NO), the CPU 61 proceeds to the process in step S53.

In step S51, the CPU 61 stores the present operation point of the speed change mechanism 30 in the memory 63. That is, when the determination coefficient MP is set to “2”, the CPU 61 causes the memory 63 to store the present operation point of the speed change mechanism 30 as an operation point for a case where resonance is generated in in-vehicle devices other than the speed change device 20 because of operation of the speed change device 20. When the determination coefficient MP is set to “3”, meanwhile, the CPU 61 causes the memory 63 to store the present operation point of the speed change mechanism 30 as an operation point for a case where resonance is generated in the belt 37 because of operation of the other in-vehicle devices. Then, the CPU 61 proceeds to the process in the next step S53.

In step S53, the CPU 61 determines whether the determination coefficient MP is set to “3”. When the determination coefficient MP is not set to “3” (S53: NO), the CPU 61 proceeds to the process in step S55. Then, the CPU 61 increments the determination coefficient MP by “1” in step S55, and thereafter proceeds to the process in step S33. When the determination coefficient MP is set to “3” in step S53 (YES), on the other hand, the CPU 61 temporarily ends the sequence of processes.

The function of the present embodiment will be described. When no abnormality is caused in the belt 37, the input rotational speeds Ninp and the output rotational speeds Noutp are fluctuated at periods that match an engine rotational speed NE. FIG. 6 illustrates transitions in the input rotational speeds Ninp and the output rotational speeds Noutp for a case where the engine rotational speed NE is constant. When an abnormality such as damage to an element 372 of the belt 37 is caused in the belt 37, on the other hand, vibration components due to the damage are superimposed on the input rotational speeds Ninp and the output rotational speeds Noutp. As a result, the input rotational speeds Ninp and the output rotational speeds Noutp transition as illustrated in FIG. 7.

In the present embodiment, the input rotational speed-related data RDNinp that are based on the chronological data on the input rotational speeds Ninp, and the output rotational speed-related data RDNoutp that are based on the chronological data on the output rotational speeds Noutp are input as the input variables x to the mapping that is prescribed by the mapping data DM1. Then, the output variable Y (1) is output from the mapping. The output variable Y (1) has a value determined in consideration of transitions in the input rotational speeds Ninp and transitions in the output rotational speeds Noutp. Therefore, there is a difference in the output variable Y (1) between a case where vibration components due to an abnormality in the belt 37 are superimposed on at least one of the input rotational speeds Ninp and the output rotational speeds Noutp and a case where vibration components due to an abnormality in the belt 37 are not superimposed on any of the input rotational speeds Ninp and the output rotational speeds Noutp. Therefore, it is possible to determine whether an abnormality is caused in the belt 37 by evaluating the output variable Y (1).

The following effects can be further obtained with the present embodiment.

(1-1) In the present embodiment, the chronological data on the normalized input rotational speeds NinpN are derived by normalizing the chronological data on the input rotational speeds Ninp. Then, the input rotational speed-related data RDNinp are generated based on the chronological data on the normalized input rotational speeds NinpN. Therefore, the degree of the difference between the input rotational speed-related data RDNinp for a case where an abnormality is caused in the belt 37 and the input rotational speed-related data RDNinp for a case where no abnormality is caused is not so large between a case where the input rotational speeds Ninp are high and a case where the input rotational speeds Ninp are low. Thus, it is possible to suppress fluctuations in the precision in determination due to variations in the input rotational speeds Ninp, by using, as an input variable for the mapping, the input rotational speed-related data RDNinp that are generated based on the chronological data on the normalized input rotational speeds NinpN.

(1-2) The precision in determination can be enhanced better as the chronological data on the normalized input rotational speeds NinpN contain a larger number of data. In the present embodiment, the input rotational speed-related data RDNinp that are used as an input variable for the mapping are obtained by representing the chronological data on the normalized input rotational speeds NinpN in a histogram. Therefore, the data volume of the input rotational speed-related data RDNinp is not increased significantly even if the chronological data contain a large number of data. Thus, the determination can be made precisely while suppressing an increase in the amount of data as an input variable.

(1-3) In the present embodiment, the chronological data on the normalized output rotational speeds NoutpN are derived by normalizing the chronological data on the output rotational speeds Noutp. Then, the output rotational speed-related data RDNoutp are generated based on the chronological data on the normalized output rotational speeds NoutpN. Therefore, the degree of the difference between the output rotational speed-related data RDNoutp for a case where an abnormality is caused in the belt 37 and the output rotational speed-related data RDNoutp for a case where no abnormality is caused is not so large between a case where the output rotational speeds Noutp are high and a case where the output rotational speeds Noutp are low. Thus, it is possible to suppress fluctuations in the precision in determination due to variations in the output rotational speeds Noutp, by using, as an input variable for the mapping, the output rotational speed-related data RDNoutp that are generated based on the chronological data on the normalized output rotational speeds NoutpN.

(1-4) The precision in determination can be enhanced better as the chronological data on the normalized output rotational speeds NoutpN contain a larger number of data. In the present embodiment, the output rotational speed-related data RDNoutp that are used as an input variable for the mapping are obtained by representing the chronological data on the normalized output rotational speeds NoutpN in a histogram. Therefore, the data volume of the output rotational speed-related data RDNoutp is not increased significantly even if the chronological data contain a large number of data. Thus, the determination can be made precisely while suppressing an increase in the amount of data as an input variable.

(1-5) Even under circumstances in which an abnormality is not caused in the belt 37, the magnitude and the period of vibration of the input rotational speeds Ninp and the output rotational speeds Noutp may be different between a case where the input torque Trq is large and a case where the input torque Trq is small. Thus, in the present embodiment, the input torque Trq is used as an input variable for the mapping. Therefore, the output variable Y (MP) that is output from the mapping has a value determined in consideration of the input torque Trq. Thus, the precision in determination can be enhanced by making the determination based on the output variable Y (MP).

(1-6) The viscosity of oil is lower as the temperature of the oil is higher. The degree of slipping of the belt 37 with respect to the input pulley 33 and the degree of slipping of the belt 37 with respect to the output pulley 35 tend to be larger as the viscosity of oil that circulates in the speed change mechanism 30 is lower. The mode of vibration of the input rotational speeds Ninp and the mode of vibration of the output rotational speeds Noutp may be varied, even under circumstances in which an abnormality is not caused in the belt 37, when the degree of slipping is different. Thus, in the present embodiment, the oil temperature detection value Toil is used as an input variable for the mapping. That is, the output variable Y (MP) that is output from the mapping has a value determined in consideration of the viscosity of the oil. Therefore, the precision in determination can be enhanced by making the determination based on the output variable Y (MP).

(1-7) Vibration components due to the shape of the belt 37 may be superimposed on the input rotational speeds Ninp and the output rotational speeds Noutp. Such vibration components are not due to an abnormality caused in the belt 37. In the present embodiment, the belt shape index MVs for each speed change device 20 is stored in the memory 63. The belt shape index MVs is input to the mapping as an input variable. That is, the output variable Y (MP) that is output from the mapping has a value determined in consideration of the shape of the belt 37. Therefore, the precision in determination can be enhanced by making the determination based on the output variable Y (MP).

(1-8) Vibration components due to the shape of constituent parts of the belt 37 may be superimposed on the input rotational speeds Ninp and the output rotational speeds Noutp. Such vibration components are not due to an abnormality caused in the belt 37. Thus, in the present embodiment, the element shape index MVEs for each speed change device 20 is stored in the memory 63. The element shape index MVEs is input to the mapping as an input variable. That is, the output variable Y (MP) that is output from the mapping has a value determined in consideration of the shape of the elements 372 that are constituent parts of the belt 37. Therefore, the precision in determination can be enhanced by making the determination based on the output variable Y (MP).

(1-9) When the amount of backlash in the rotational direction of the elements 372 of the belt 37 is large, vibration components that match the amount of backlash tend to be superimposed on the input rotational speeds Ninp and the output rotational speeds Noutp. Thus, in the present embodiment, the backlash amount index MVRa that is an index of the amount of backlash is stored in the memory 63. The backlash amount index MVRa is input to the mapping as an input variable. That is, the output variable Y (MP) that is output from the mapping has a value determined in consideration of the amount of backlash. Therefore, the precision in determination can be enhanced by making the determination based on the output variable Y (MP).

(1-10) The degree of slipping caused between the input pulley 33 and the belt 37 may be varied in accordance with the input engagement force Pinp. The mode of vibration of the input rotational speeds Ninp and the output rotational speeds Noutp may be varied when the degree of slipping is varied. Thus, in the present embodiment, the input engagement force Pinp is used as an input variable for the mapping. That is, the output variable Y (MP) that is output from the mapping has a value determined in consideration of the degree of slipping caused between the input pulley 33 and the belt 37. Therefore, the precision in determination can be enhanced by making the determination based on the output variable Y (MP).

(1-11) The degree of slipping caused between the output pulley 35 and the belt 37 may be varied in accordance with the output engagement force Poutp. The mode of vibration of the input rotational speeds Ninp and the output rotational speeds Noutp may be varied when the degree of slipping is varied. Thus, in the present embodiment, the output engagement force Poutp is used as an input variable for the mapping. That is, the output variable Y (MP) that is output from the mapping has a value determined in consideration of the degree of slipping caused between the output pulley 35 and the belt 37. Therefore, the precision in determination can be enhanced by making the determination based on the output variable Y (MP).

(1-12) When an abnormality is caused in the belt 37 and vibration due to the abnormality is superimposed on the input rotational speeds Ninp and the output rotational speeds Noutp, the vibration due to the abnormality may be transmitted to the vehicle body to vary the vehicle acceleration G. Thus, in the present embodiment, the vehicle acceleration G is used as an input variable for the mapping. That is, the output variable Y (MP) that is output from the mapping is determined in consideration of the vehicle acceleration G. Therefore, the precision in determination can be enhanced by making the determination based on the output variable Y (MP).

(1-13) When an abnormality is caused in the belt 37 and vibration due to the abnormality is superimposed on the input rotational speeds Ninp and the output rotational speeds Noutp, an abnormal sound due to the vibration may be generated in the speed change mechanism 30. Such an abnormal sound can be detected by the sound sensor 107 that is installed in the engine compartment. Thus, in the present embodiment, the sound detection value Snd is used as an input variable for the mapping. That is, the output variable Y (MP) that is output from the mapping is determined in consideration of the sound detection value Snd. Therefore, the precision in determination can be enhanced by making the determination based on the output variable Y (MP).

(1-14) When the braking force BPvc of the vehicle VC is generated, the drive wheels 50 are decelerated, and therefore the input rotational speeds Ninp and the output rotational speeds Noutp are also varied. In this event, vibration components due to the magnitude of the braking force BPvc or the speed of increase in the braking force BPvc may be superimposed on the input rotational speeds Ninp and the output rotational speeds Noutp. Thus, in the present embodiment, the braking force BPvc is used as an input variable for the mapping. That is, the output variable Y (MP) that is output from the mapping has a value determined in consideration of the braking force BPvc. Therefore, the precision in determination can be enhanced by making the determination based on the output variable Y (MP).

(1-15) When an abnormality is caused in the belt 37 and therefore vibration is superimposed on the input rotational speeds Ninp and the output rotational speeds Noutp, the rotational speed ratio RN may be different between a case where no abnormality is caused and a case where an abnormality is caused. Thus, in the present embodiment, the rotational speed ratio RN is used as an input variable for the mapping. That is, the output variable Y (MP) that is output from the mapping has a value determined in consideration of the rotational speed ratio RN. Therefore, the precision in determination can be enhanced by making the determination based on the output variable Y (MP).

(1-16) Even when an abnormality is not caused in the belt 37, the magnitude and the period of vibration of the input rotational speeds Ninp and the output rotational speeds Noutp may be varied between when the degree of temporal variations in the characteristics of the belt 37 is relatively small and the degree of such temporal variations is relatively large. Thus, in the present embodiment, the travel distance SC that is an example of an index indicating the degree of temporal variations in the characteristics is used as an input variable for the mapping. That is, the output variable Y (MP) that is output from the mapping has a value determined in consideration of the degree of temporal variations in the characteristics of the belt 37. Therefore, the precision in determination can be enhanced by making the determination based on the output variable Y (MP).

(1-17) In the present embodiment, it is possible to determine whether resonance is generated in the other in-vehicle devices because of vibration of the belt 37, by inputting the input variables to the mapping that is prescribed by the mapping data DM2 and evaluating the output variable Y (2) that is output from the mapping. Consequently, a factor of generation of resonance in the other in-vehicle devices can be specified.

In this case, it is possible to grasp an operation point of the speed change mechanism 30 at which resonance is generated in the other in-vehicle devices. In the present embodiment, such an operation point is stored in the memory 63. It is possible to suppress generation of resonance in the other in-vehicle devices during travel of the vehicle VC by controlling the internal combustion engine 10 and the speed change device 20 such that the operation point of the speed change mechanism 30 does not match the operation point stored in the memory 63.

(1-18) In the present embodiment, it is possible to determine whether resonance is generated in the belt 37 because of operation of the other in-vehicle devices, by inputting the input variables to the mapping that is prescribed by the mapping data DM3 and evaluating the output variable Y (3) that is output from the mapping. Consequently, a factor of generation of resonance in the belt 37 can be specified.

In this case, it is possible to grasp an operation point of the speed change mechanism 30 at which resonance is generated in the belt 37. In the present embodiment, such an operation point is stored in the memory 63. It is possible to suppress generation of resonance in the belt 37 during travel of the vehicle VC by controlling the internal combustion engine 10 and the speed change device 20 such that the operation point of the speed change mechanism 30 does not match the operation point stored in the memory 63.

### Second Embodiment

A second embodiment will be described below with reference to the drawings, mainly with regard to differences from the first embodiment.

The present embodiment is different from the first embodiment in the method of generating the input rotational speed-related data RDNinp and the output rotational speed-related data RDNoutp.

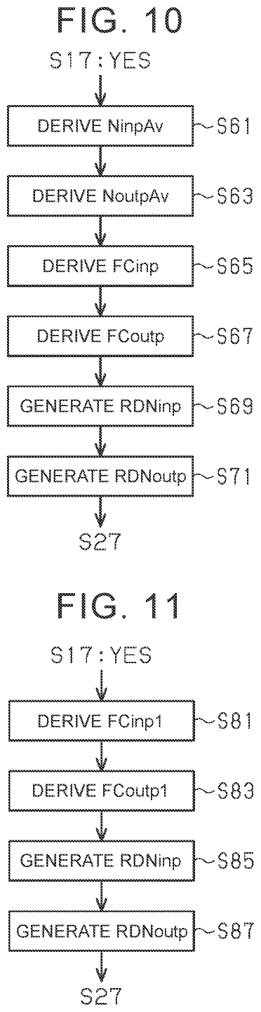

The procedures of a sequence of processes executed by the control device 60 in order to make various determinations as described above will be described with reference to FIG. 10. FIG. 10 illustrates a part of the procedures of the sequence of processes executed by the control device 60 in order to make the various determinations.

First, the CPU 61 acquires chronological data on the input rotational speeds Ninp and chronological data on the output rotational speeds Noutp through execution of processes that are equivalent to those in steps S11 to S17. Then, the CPU 61 proceeds to the process in step S61. In step S61, the CPU 61 derives an input rotational speed average value NinpAv that is an average value of the input rotational speeds Ninp during an acquisition period for the chronological data on the input rotational speeds Ninp. For example, the CPU 61 may derive, as the input rotational speed average value NinpAv, the average value of all the input rotational speeds Ninp (1), Ninp (2), . . . , and Ninp (z) included in the acquired chronological data on the input rotational speeds Ninp. Subsequently, in step S63, the CPU 61 derives an output rotational speed average value NoutpAv that is an average value of the output rotational speeds Noutp during an acquisition period for the chronological data on the output rotational speeds Noutp. For example, the CPU 61 may derive, as the output rotational speed average value NoutpAv, the average value of all the output rotational speeds Noutp (1), Noutp (2), . . . , and Noutp (z) included in the acquired chronological data on the output rotational speeds Noutp.

In the next step S65, the CPU 61 derives input frequency characteristics FCinp based on the chronological data on the input rotational speeds Ninp and the input rotational speed average value NinpAv. The input frequency characteristics FCinp are the frequency characteristics of the input rotational speeds Ninp. That is, the CPU 61 derives the frequency characteristics of the chronological data on the input rotational speeds Ninp by performing a fast Fourier transform on the chronological data on the input rotational speeds Ninp. The frequency characteristics represent the relationship between the frequency and any physical quantity. In the present embodiment, the frequency characteristics represent the relationship between the frequency and the intensity. The CPU 61 acquires the amplitude of the primary frequency of rotation of the belt 37 based on the input rotational speed average value NinpAv. Specifically, the primary frequency of the rotation is determined as a value obtained by dividing the input rotational speed average value [rpm] by 60. The CPU 61 derives the input frequency characteristics FCinp by standardizing, using the amplitude of the primary frequency of the rotation, the frequency characteristics of the chronological data on the input rotational speeds Ninp that are derived by performing a fast Fourier transform. Examples of the standardization method include Max/Min Scalar and Standard Scalar. That is, the input frequency characteristics FCinp are standardized frequency characteristics.

In the next step S67, the CPU 61 derives output frequency characteristics FCoutp based on the chronological data on the output rotational speeds Noutp and the output rotational speed average value NoutpAv. The output frequency characteristics FCoutp are the frequency characteristics of the output rotational speeds Noutp. That is, the CPU 61 derives the frequency characteristics of the chronological data on the output rotational speeds Noutp by performing a fast Fourier transform on the chronological data on the output rotational speeds Noutp. The CPU 61 acquires the amplitude of the primary frequency of rotation of the belt 37 based on the output rotational speed average value NoutpAv. The CPU 61 derives the output frequency characteristics FCoutp by standardizing, using the amplitude of the primary frequency of rotation, the frequency characteristics of the chronological data on the output rotational speeds Noutp that are derived by performing a fast Fourier transform. That is, the output frequency characteristics FCoutp are standardized frequency characteristics.

Subsequently, in step S69, the CPU 61 generates input rotational speed-related data RDNinp based on the input frequency characteristics FCinp. For example, the CPU 61 uses the input frequency characteristics FCinp as the input rotational speed-related data RDNinp. In the next step S71, the CPU 61 generates output rotational speed-related data RDNoutp based on the output frequency characteristics FCoutp. For example, the CPU 61 uses the output frequency characteristics FCoutp as the output rotational speed-related data RDNoutp.

Then, the CPU 61 proceeds to the process in step S27. The subsequent processes are similar to those according to the first embodiment, and therefore are not described in detail here.

With the present embodiment, the following effects can be further obtained in addition to effects that are equivalent to the effects in (1-5) to (1-18) described in relation to the above embodiment.

(2-1) In the present embodiment, the input frequency characteristics FCinp are derived by performing a fast Fourier transform on the chronological data on the input rotational speeds Ninp. Then, the input rotational speed-related data RDNinp are generated based on the input frequency characteristics FCinp. There may be a difference between the input rotational speed-related data RDNinp for a case where an abnormality that may vary the input frequency characteristics FCinp is caused in the belt 37 and the input rotational speed-related data RDNinp generated when no such abnormality is caused. Therefore, when an abnormality that may characterize the input frequency characteristics FCinp is caused in the belt 37, it is possible to determine that an abnormality is caused using the output variable Y that is output from the mapping upon receiving, as an input variable for the mapping, the input rotational speed-related data RDNinp that are generated based on the input frequency characteristics FCinp.

(2-2) In the present embodiment, the amplitude of the primary frequency of the rotation of the belt 37 is acquired based on the input rotational speed average value NinpAv. Then, the input frequency characteristics FCinp are derived by standardizing, using the amplitude of the primary frequency of the rotation, the frequency characteristics of the input rotational speeds Ninp that are derived through a fast Fourier transform. The magnitude of a characteristic amount due to an abnormality that emerges in the thus standardized input frequency characteristics FCinp is not varied significantly between a case where the input rotational speeds Ninp are high and a case where the input rotational speeds Ninp are low. As a result, it is possible to suppress fluctuations in the precision in determination due to variations in the input rotational speeds Ninp, by using, as an input variable for the mapping, the input rotational speed-related data RDNinp that are generated based on the standardized input frequency characteristics FCinp.

(2-3) In the present embodiment, the output frequency characteristics FCoutp are derived by performing a fast Fourier transform on the chronological data on the output rotational speeds Noutp. Then, the output rotational speed-related data RDNoutp are generated based on the output frequency characteristics FCoutp. There may be a difference between the output rotational speed-related data RDNoutp for a case where an abnormality that may vary the output frequency characteristics FCoutp is caused in the belt 37 and the output rotational speed-related data RDNoutp generated when no such abnormality is caused. Therefore, when an abnormality that may characterize the output frequency characteristics FCoutp is caused in the belt 37, it is possible to determine that an abnormality is caused using the output variable Y that is output from the mapping upon receiving, as an input variable for the mapping, the output rotational speed-related data RDNoutp that are generated based on the output frequency characteristics FCoutp.

(2-4) In the present embodiment, the amplitude of the primary frequency of the rotation of the belt 37 is acquired based on the output rotational speed average value NoutpAv. Then, the output frequency characteristics FCoutp are derived by standardizing, using the amplitude of the primary frequency of the rotation, the frequency characteristics of the output rotational speeds Noutp that are derived through a fast Fourier transform. The magnitude of the characteristic amount due to an abnormality that emerges in the thus standardized output frequency characteristics FCoutp is not varied significantly between a case where the output rotational speeds Noutp are high and a case where the output rotational speeds Noutp are low. As a result, it is possible to suppress fluctuations in the precision in determination due to variations in the output rotational speeds Noutp, by using, as an input variable for the mapping, the output rotational speed-related data RDNoutp that are generated based on the standardized output frequency characteristics FCoutp.

### Third Embodiment

A third embodiment will be described below with reference to the drawings, mainly with regard to differences from the first and second embodiments.

In the present embodiment, the frequency characteristics of the chronological data on the input rotational speeds Ninp are derived by performing a fast Fourier transform on such chronological data. Then, the input rotational speed-related data RDNinp are generated based on the frequency characteristics of the chronological data. Meanwhile, the frequency characteristics of the chronological data on the output rotational speeds Noutp are derived by performing a fast Fourier transform on such chronological data. Then, the output rotational speed-related data RDNoutp are generated based on the frequency characteristics of the chronological data.

The procedures of a sequence of processes executed by the control device 60 in order to make various determinations as described above will be described with reference to FIG. 11. FIG. 11 illustrates a part of the procedures of the sequence of processes executed by the control device 60 in order to make the various determinations.

First, the CPU 61 acquires chronological data on the input rotational speeds Ninp and chronological data on the output rotational speeds Noutp through execution of processes that are equivalent to those in steps S11 to S17. Then, the CPU 61 proceeds to the process in step S81. In step S81, the CPU 61 derives input frequency characteristics FCinp1 based on the chronological data on the input rotational speeds Ninp. The input frequency characteristics FCinp1 are the frequency characteristics of the input rotational speeds Ninp. That is, the CPU 61 divides the frequency band, in which data on the frequency characteristics derived by performing a fast Fourier transform on the chronological data on the input rotational speeds Ninp are distributed, into m equal frequency bands. Then, the CPU 61 derives, as the input frequency characteristics FCinp1, data obtained by averaging the data on the frequency characteristics for each of the frequency bands. This is achieved by performing a ⅓ octave band analysis on the frequency characteristics, for example. In the present embodiment, “m” is set to an integer of “2” or more.

In the next step S83, the CPU 61 derives output frequency characteristics FCoutp1 based on the chronological data on the output rotational speeds Noutp. The output frequency characteristics FCoutp1 are the frequency characteristics of the output rotational speeds Noutp. That is, the CPU 61 divides the frequency band, in which data on the frequency characteristics derived by performing a fast Fourier transform on the chronological data on the output rotational speeds Noutp are distributed, into m equal frequency bands. Then, the CPU 61 derives, as the output frequency characteristics FCoutp1, data obtained by averaging the data on the frequency characteristics for each of the frequency bands. In the present embodiment, “m” is set to an integer of “2” or more.

Subsequently, in step S85, the CPU 61 generates input rotational speed-related data RDNinp based on the input frequency characteristics FCinp1. For example, the CPU 61 uses the input frequency characteristics FCinp1 as the input rotational speed-related data RDNinp. In the next step S87, the CPU 61 generates output rotational speed-related data RDNoutp based on the output frequency characteristics FCoutp1. For example, the CPU 61 uses the output frequency characteristics FCoutp1 as the output rotational speed-related data RDNoutp.

Then, the CPU 61 proceeds to the process in step S27. The subsequent processes are similar to those according to the first and second embodiments, and therefore are not described in detail here.

With the present embodiment, the following effects can be further obtained in addition to effects that are equivalent to the effects in (1-5) to (1-18), (2-1), and (2-3) described in relation to the above embodiments.

(3-1) In the present embodiment, the frequency band, in which data derived by performing a fast Fourier transform on the chronological data on the input rotational speeds Ninp are distributed, is divided into m equal frequency bands. The input rotational speed-related data RDNinp are generated based on data averaged for each frequency band as described above. It is possible to suppress an increase in the number of data to be input to the mapping, by using, as an input variable for the mapping, the input rotational speed-related data RDNinp that are generated by averaging data for each frequency band as described above.

(3-2) In the present embodiment, the frequency band, in which data derived by performing a fast Fourier transform on the chronological data on the output rotational speeds Noutp are distributed, is divided into m equal frequency bands. The output rotational speed-related data RDNoutp are generated based on data averaged for each frequency band as described above. It is possible to suppress an increase in the number of data to be input to the mapping, by using, as an input variable for the mapping, the output rotational speed-related data RDNoutp that are generated by averaging data for each frequency band as described above.

The control device 60 is an example of the abnormality determination device. The vehicle VC is an example of the vehicle. The internal combustion engine 10 is an example of the power source of the vehicle. The drive wheels 50 are an example of the drive wheels. The speed change device 20 is an example of the power transfer device. The input pulley 33 is an example of the input pulley. The output pulley 35 is an example of the output pulley. The belt 37 is an example of the endless rotary member. The CPU 61 and the ROM 62 are an example of the execution device. The memory 63 is an example of the memory. The input rotational speeds Ninp are an example of the input rotational speeds. The input rotational speed-related data RDNinp are an example of the input rotational speed-related data. The output rotational speeds Noutp are an example of the output rotational speeds. The output rotational speed-related data RDNoutp are an example of the output rotational speed-related data. The output variable Y (MP) is an example of the output variable. The mapping data DM1 to DM3 illustrated in FIG. 1 are an example of the mapping data. The processes in steps S11 to S27 illustrated in FIGS. 4 and 5, the processes in steps S61 to S71 illustrated in FIG. 10, and the processes in steps S81 to S87 illustrated in FIG. 11 are an example of the acquisition process. The processes in steps S35 to S41 for a case where the determination coefficient MP is set to “1” in FIGS. 4 and 5 are an example of the abnormality determination process.

The period since the time when the coefficient z is set to “1” in step S11 until the time when it is determined that the coefficient z is more than the coefficient determination value zTh in step S17 in FIGS. 4 and 5 is an example of the measurement period. The cycle of execution of the process in step S13 in FIGS. 4 and 5 is an example of the detection cycle. The processes in steps S11 to S17 illustrated in FIGS. 4 and 5 are an example of the rotational speed acquisition process. The process in step S19 and the process in step S23 illustrated in FIGS. 4 and 5 are an example of the generation process.

The process in step S21 and the process in step S25 illustrated in FIGS. 4 and 5 are an example of the generation process.

The process in step S65 and the process in step S69 illustrated in FIG. 10 are an example of the frequency characteristics generation process. The process in step S81 and the process in step S85 illustrated in FIG. 11 are another example of the frequency characteristics generation process.

The period since the time when the coefficient z is set to “1” in step S11 until the time when it is determined that the coefficient z is more than the coefficient determination value zTh in step S17 in FIGS. 4 and 5 is an example of the acquisition period for the chronological data on the input rotational speeds. The process in step S61 illustrated in FIG. 10 is an example of the average value calculation process. The process in step S65 and the process in step S69 illustrated in FIG. 10 are an example of the frequency characteristics generation process.

The process in step S81 and the process in step S85 illustrated in FIG. 11 are an example of the frequency characteristics generation process.

The process in step S67 and the process in step S71 illustrated in FIG. 10 and the process in step S83 and the process in step S87 illustrated in FIG. 11 are an example of the frequency characteristics generation process.

The period since the time when the coefficient z is set to “1” in step S11 until the time when it is determined that the coefficient z is more than the coefficient determination value zTh in step S17 in FIGS. 4 and 5 is an example of the acquisition period for the chronological data on the output rotational speeds. The process in step S63 illustrated in FIG. 10 is an example of the average value calculation process. The process in step S67 and the process in step S71 illustrated in FIG. 10 are an example of the frequency characteristics generation process.

The process in step S83 and the process in step S87 illustrated in FIG. 11 are an example of the frequency characteristics generation process.

The input torque Trq is an example of the torque.

The oil temperature detection value Toil is an example of the temperature of oil.

The belt shape index MVs is an example of the index that indicates the shape of the endless rotary member. The element shape index MVEs is an example of the index that indicates the shape of the constituent parts of the endless rotary member.

The input engagement force Pinp is an example of the force with which the input pulley holds the endless rotary member. The output engagement force Poutp is an example of the force with which the output pulley holds the endless rotary member.

The backlash amount index MVRa is an example of the index that indicates the amount of backlash.

The acceleration sensor 106 is an example of the acceleration sensor. The vehicle acceleration G is an example of the detection value of the acceleration sensor.

The sound sensor 107 is an example of the sound sensor. The sound detection value Snd is an example of the detection value of the sound sensor.

The wheel speed VW is an example of the rotational speed of the drive wheels.

The braking force BPvc is an example of the braking force of the vehicle.

The rotational speed ratio RN is an example of the ratio between the rotational speeds of the input pulley and the output pulley.

The travel distance SC is an example of the index that indicates the degree of temporal variations in characteristics.

The elements 372 are an example of the constituent parts of the endless rotary member.

The processes in steps S47 and S49 for a case where the determination coefficient MP is set to “2” in FIGS. 4 and 5 are an example of the vibration determination process.

The processes in steps S47 and S49 for a case where the determination coefficient MP is set to “3” in FIGS. 4 and 5 are an example of the resonance determination process.

### Modifications

The above embodiments may be modified as follows. The above embodiments and the following modifications can be combined with each other unless such embodiments and modifications technically contradict with each other.

### Mapping

In the embodiments described above, the activation functions of the mapping are exemplary, and are not limited to those according to the embodiments described above. For example, a logistic sigmoid function may be adopted as the activation functions of the mapping.

In the embodiments described above, a neural network with a single intermediate layer is indicated as an example of the neural network. However, the neural network may include two or more intermediate layers.

In the embodiments described above, a fully-connected forward-propagation neural network is indicated as an example of the neural network. However, the present disclosure is not limited thereto. For example, a recurrent neural network may be adopted as the neural network. A recurrent neural network is preferably adopted when the chronological data on the normalized input rotational speeds NinpN, the chronological data on the input rotational speeds Ninp, the chronological data on the normalized output rotational speeds NoutpN, and the chronological data on the output rotational speeds Noutp are used as input variables for the mapping as discussed later.

### Mapping Data

In the embodiments described above, the memory 63 stores the mapping data DM1 for determination as to whether an abnormality is caused in the constituent parts of the speed change mechanism 30, the mapping data DM2 for determination as to whether resonance is generated in the other in-vehicle devices because of operation of the speed change mechanism 30, and the mapping data DM3 for determination as to whether the belt 37 is resonated because of operation of the other in-vehicle devices. However, the present disclosure is not limited thereto. For example, the memory 63 may store mapping data that prescribe mapping that outputs an output variable that allows all the three determinations described above to be made.

In the embodiments described above, the memory 63 may not store the mapping data DM2 as long as the memory 63 stores the mapping data DM1. In addition, the memory 63 may not store the mapping data DM3 as long as the memory 63 stores the mapping data DM1. Also in this case, it can be determined whether an abnormality is caused in the belt 37 by inputting the input variables to the mapping that is prescribed by the mapping data DM1 and using the output variable that is output from the mapping.

### Input Variables

A parameter other than the travel distance SC may be used as the index that indicates the degree of temporal variations in the characteristics of the endless rotary member. For example, the total value of the time for which the belt 37 operates and the number of times when the belt 37 operates may be used as input variables for the mapping, as the index that indicates the degree of temporal variations in the characteristics of the endless rotary member.

The input variables may not include an index that indicates the degree of temporal variations in the characteristics of the endless rotary member.

The input variables may not include the rotational speed ratio RN.

The difference between the input rotational speeds Ninp and the output rotational speeds Noutp may be used as an input variable for the mapping in place of the rotational speed ratio RN.

Chronological data on the rotational speed ratio RN may be acquired, and a plurality of rotational speed ratios RN included in the chronological data on the rotational speed ratio RN may be used as an input variable for the mapping.

The input variables may not include the braking force BPvc.

When the input variables do not include the braking force BPvc, it may be used as an input variable whether a braking force is applied to the drive wheels 50. In addition, the amount of decrease in the rotational speed of the drive wheels 50 per unit time may be used as an input variable.

When the input variables do not include the braking force BPvc, the sequence of processes illustrated in FIGS. 4 and 5, for example, may not be executed when the vehicle is braked.

The input variables may not include the sound detection value Snd. In this case, the control device 60 is applicable to the vehicle VC on which the sound sensor 107 is not mounted.

The input variables may not include the vehicle acceleration G.

The input variables may not include the backlash amount index MVRa.

The input variables may not include the input engagement force Pinp.

The input variables may not include the output engagement force Poutp.

The memory 63 may store the shape of the elements 372 as the element shape index MVEs. In this case, the element shape index MVEs may be input to the mapping as an input variable.

The input variables may not include the element shape index MVEs.

The input variables may not include the belt shape index MVs.

The input variables may not include the oil temperature detection value Toil.

The input variables may not include the input torque Trq.

The input variables may not include the output rotational speed-related data RDNoutp as long as the input variables include the input rotational speed-related data RDNinp.

The input variables may not include the input rotational speed-related data RDNinp as long as the input variables include the output rotational speed-related data RDNoutp.

### Input Rotational Speed-Related Data

In the second embodiment described above, the frequency characteristics of the chronological data on the input rotational speeds Ninp that are derived by performing a fast Fourier transform on such chronological data may be used as the input rotational speed-related data RDNinp. That is, a plurality of input rotational speeds Ninp included in the chronological data on the input rotational speeds Ninp may not be normalized.

In the first embodiment described above, the input rotational speed-related data RDNinp are composed of “five” count values Cnt (1) to Cnt (5). However, the number of count values is not limited to “five”. For example, when the region of numerical values from “0” to “1” is divided for every “0.1”, the input rotational speed-related data RDNinp may be data composed of “ten” count values Cnt (1) to Cnt (10).

In the first embodiment described above, the input rotational speed-related data may not be the input rotational speed-related data RDNinp. That is, the input rotational speed-related data may be the chronological data on the normalized input rotational speeds NinpN.

The input rotational speed-related data may be the chronological data on the input rotational speeds Ninp.

### Output Rotational Speed-Related Data

In the second embodiment described above, the frequency characteristics of the chronological data on the output rotational speeds Noutp that are derived by performing a fast Fourier transform on such chronological data may be used as the output rotational speed-related data RDNoutp. That is, a plurality of output rotational speeds Noutp included in the chronological data on the output rotational speeds Noutp may not be normalized.

In the first embodiment described above, the output rotational speed-related data RDNoutp are composed of “five” count values Cnt (1) to Cnt (5). However, the number of count values is not limited to “five”. For example, when the region of numerical values from “0” to “1” is divided for every “0.1”, the output rotational speed-related data RDNoutp may be data composed of “ten” count values Cnt (1) to Cnt (10).

In the first embodiment described above, the output rotational speed-related data may not be the output rotational speed-related data RDNoutp. That is, the output rotational speed-related data may be the chronological data on the normalized output rotational speeds NoutpN.

The output rotational speed-related data may be the chronological data on the output rotational speeds Noutp.

### Output Rotational Speeds

In the embodiments described above, a value based on the output signal Soutp from the output shaft rotational angle sensor 103 is acquired as the output rotational speeds Noutp. However, the present disclosure is not limited thereto. For example, a value calculated based on the wheel speed VW that is the rotational speed of the drive wheels 50 may be acquired as the output rotational speeds Noutp. In this event, the output rotational speeds Noutp can be calculated by dividing the wheel speed VW by the speed reduction ratio of a torque transfer path from the output pulley 35 to the drive wheels 50.

### Execution Device

The execution device is not limited to one that includes the CPU 61 and the ROM 62 to execute software processing. For example, the execution device may include a dedicated hardware circuit that performs hardware processing for at least some of processes subjected to software processing in the embodiments described above. Examples of the dedicated hardware circuit may include an application specific integrated circuit (ASIC). The ASIC is an abbreviation for “Application Specific Integrated Circuit”. That is, the execution device may have any of the following configurations (a) to (c).

(a) The execution device includes a processing device that executes all of the processes described above in accordance with a program and a program storage device, such as a ROM, that stores the program.

(b) The execution device includes a processing device that executes some of the processes described above in accordance with a program, a program storage device, and a dedicated hardware circuit that executes the remaining processes.

(c) The execution device includes a dedicated hardware circuit that executes all of the processes described above. The execution device may include a plurality of software execution devices that each include a processing device and a program storage device, and a plurality of dedicated hardware circuits.

### Power Transfer Device

The power transfer device may be configured differently from the speed change device 20 illustrated in FIG. 1 as long as the power transfer device includes an endless rotary member. For example, the speed change device may include a speed change mechanism that includes a chain as the endless rotary member. In addition, the power transfer device may not have a speed change function as long as the power transfer device is configured to include an input pulley, an output pulley, and an endless rotary member.

### Vehicle

The vehicle may be a hybrid vehicle. Alternatively, the vehicle may be a vehicle that includes a motor/generator but that does not include an internal combustion engine, for example. In this case, the motor/generator corresponds to the power source of the vehicle.

What is claimed is:

1. A device for a vehicle including a power transfer device, the power transfer device having an input pulley to which torque is input, an output pulley that outputs torque toward drive wheels of the vehicle, and an endless rotary member wound around both the input pulley and the output pulley, the device comprising:
a memory configured to store mapping data that include data that prescribe mapping that represents correspondence between an input variable and an output variable, the data being learned through machine learning,
the input variable being at least one of:
i) input rotational speed-related data based on chronological data on input rotational speeds that are rotational speeds of the input pulley; and
ii) output rotational speed-related data based on chronological data on output rotational speeds that are rotational speeds of the output pulley,
the output variable specifying whether an abnormality is caused in the endless rotary member; and
a processor configured to
acquire the input variable,
acquire the output variable corresponding to the input variable using the mapping data, and
determine, based on the output variable, whether an abnormality is caused in the endless rotary member.

2. The device according to claim 1, wherein:
the input variable includes the input rotational speed-related data; and
the processor is configured to
acquire, as the chronological data on the input rotational speeds, a plurality of the input rotational speeds detected in each detection cycle in a predetermined measurement period, and
generate the input rotational speed-related data based on data that indicate a distribution of a magnitude of numerical values of the plurality of the input rotational speeds included in the chronological data on the input rotational speeds.

3. The device according to claim 1, wherein:
the input variable includes the input rotational speed-related data; and
the processor is configured to
acquire, as the chronological data on the input rotational speeds, a plurality of the input rotational speeds detected in each detection cycle in a predetermined measurement period,
normalize the plurality of the input rotational speeds included in the chronological data on the input rotational speeds, and
generate, as the input rotational speed-related data, data that indicate a distribution of a magnitude of numerical values of a plurality of normalized input rotational speeds obtained by normalizing the input rotational speeds.

4. The device according to claim 1, wherein:
the output variable includes the output rotational speed-related data; and
the processor is configured to
acquire, as the chronological data on the output rotational speeds, a plurality of the output rotational speeds detected in each detection cycle in a predetermined measurement period, and
generate the output rotational speed-related data based on data that indicate a distribution of a magnitude of numerical values of the plurality of the output rotational speeds included in the chronological data on the output rotational speeds.

5. The device according to claim 1, wherein:
the output variable includes the output rotational speed-related data; and
the processor is configured to
acquire, as the chronological data on the output rotational speeds, a plurality of the output rotational speeds detected in each detection cycle in a predetermined measurement period,
normalize the plurality of the output rotational speeds included in the chronological data on the output rotational speeds, and
generate, as the output rotational speed-related data, data that indicate a distribution of a magnitude of numerical values of a plurality of normalized output rotational speeds obtained by normalizing the output rotational speeds.

6. The device according to claim 1, wherein:
the input variable includes the input rotational speed-related data; and
the processor is configured to
acquire, as the chronological data on the input rotational speeds, a plurality of the input rotational speeds detected in each detection cycle in a predetermined measurement period,
derive frequency characteristics of the chronological data on the input rotational speeds by performing a fast Fourier transform on the chronological data, and
generate the input rotational speed-related data based on the frequency characteristics of the chronological data.

7. The device according to claim 6, wherein the processor is configured to:
calculate an average value of the input rotational speeds during an acquisition period for the chronological data on the input rotational speeds;
acquire, based on the average value of the input rotational speeds, an amplitude of a primary frequency of rotation of the endless rotary member;
standardize, with the amplitude of the primary frequency of the rotation, the frequency characteristics of the input rotational speeds, the frequency characteristics being derived by performing the fast Fourier transform; and
generate the input rotational speed-related data based on the standardized frequency characteristics of the input rotational speeds.

8. The device according to claim 6, wherein the processor is configured to generate the input rotational speed-related data by equally dividing frequency bands in which data derived by performing the fast Fourier transform on the chronological data on the input rotational speeds are distributed into a predetermined number of divisional frequency bands, and averaging the data for each of the divisional frequency bands.

9. The device according to claim 1, wherein:
the input variable includes the output rotational speed-related data; and
the processor is configured to
acquire, as the chronological data on the output rotational speeds, a plurality of the output rotational speeds detected in each detection cycle in a predetermined measurement period,
derive frequency characteristics of the chronological data on the output rotational speeds by performing a fast Fourier transform on the chronological data, and
generate the output rotational speed-related data based on the frequency characteristics of the chronological data.

10. The device according to claim 9, wherein the processor is configured to:
calculate an average value of the output rotational speeds during an acquisition period for the chronological data on the output rotational speeds;
acquire, based on the average value of the output rotational speeds, an amplitude of a primary frequency of rotation of the endless rotary member;
standardize, with the amplitude of the primary frequency of the rotation, the frequency characteristics of the output rotational speeds, the frequency characteristic being derived by performing the fast Fourier transform; and
generate the output rotational speed-related data based on the standardized frequency characteristics of the output rotational speeds.

11. The device according to claim 9, wherein the processor is configured to generate the output rotational speed-related data by equally dividing frequency bands in which data derived by performing the fast Fourier transform on the chronological data on the output rotational speeds are distributed into a predetermined number of divisional frequency bands, and averaging the data for each of the divisional frequency bands.

12. The device according to claim 1, wherein the input variable includes at least one of torque input to the input pulley and a temperature of oil that circulates in the power transfer device.

13. The device according to claim 1, wherein:
the memory stores at least one of
an index that indicates a shape of the endless rotary member for each power transfer device, and
an index that indicates a shape of a constituent part of the endless rotary member for each power transfer device; and
the input variable includes the index stored in the memory.

14. The device according to claim 1, wherein the input variable includes at least one of
a force with which the input pulley holds the endless rotary member, and
a force with which the output pulley holds the endless rotary member.

15. The device according to claim 1, wherein:
the memory stores an index that indicates an amount of backlash in a rotational direction of the endless rotary member for each power transfer device; and
the input variable includes the index indicating the amount of backlash and stored in the memory.

16. The device according to claim 1, wherein the input variable includes at least one of
a detection value of an acceleration sensor mounted on the vehicle,
a detection value of a sound sensor installed in an engine compartment of the vehicle,
a braking force of the vehicle,
a ratio between a rotational speed of the input pulley and a rotational speed of the output pulley, and
an index that indicates a degree of temporal variations in characteristics of the endless rotary member.

17. The device according to claim 1, wherein:
the input variable includes the output rotational speed-related data; and
the output rotational speeds are calculated based on rotational speeds of the drive wheels.

18. The device according to claim 1, wherein the processor is configured to determine, based on the output variable, whether a constituent part of the endless rotary member is damaged.

19. The device according to claim 1, wherein the processor is configured to:
acquire the output variable corresponding to the input variable using the mapping data; and
determine, based on the output variable, whether vibration that causes an in-vehicle part other than the power transfer device to resonate is generated in the endless rotary member.

20. The device according to claim 1, wherein the processor is configured to:
acquire the output variable corresponding to the input variable using the mapping data; and
determine, based on the output variable, whether resonance is generated in the endless rotary member.
